(19) United States
(12) Patent Application Publication
(10) Pub. No.: US 2010/0183234 A1
(43) Pub. Date: Jul. 22, 2010

(54) APPARATUS, METHOD, AND PROGRAM

(75) Inventor: Takeshi Aoyagi, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/688,213

(22) Filed: Jan. 15, 2010

(30) Foreign Application Priority Data
Jan. 20, 2009 (JP) 2009-010182

(51) Int. Cl. G06K 9/00

(52) U.S. Cl. 382/252

(57) ABSTRACT

It is an objective of the present invention to provide an apparatus by which the processing required to perform the average density storage method on the hardware can be performed with a higher speed.

### BACKGROUND OF THE INVENTION

1. Field of the Invention

The present invention relates to an apparatus, a method, and a program.

2. Description of the Related Art

In recent years, with the diffusion of printers, an image processing technique for converting multivalued input image data to binary or multi-stage density has been frequently used.

As an image processing technique for converting multivalued input image data to binary or multi-stage density, quantization processings such as an average density storage and an error diffusion method are generally used.

In the case of the quantization processings such as the average density storage and the error diffusion method however, the quantization result of a pixel-of-interest or the error data of the quantization result for example is subjected to various operation (e.g., multiplication, division, or addition) and the operation result is used for the quantization of a pixel following the pixel-of-interest.

In the conventional technique however, the pixel-of-interest is firstly quantized and the information obtained through the quantization (quantization result or error data of quantization result) is subjected to operation. Then, the operation result was used to quantize a pixel following the pixel-of-interest. This has caused the disadvantage as described below.

Specifically, the quantization of a pixel following the pixel-of-interest could not be carried out immediately after the quantization of the pixel-of-interest. The reason is that the quantization of the pixel-of-interest and the quantization of a pixel following the pixel-of-interest have therebetween a operation requiring a long-time calculation.

This has consequently prevented a high-speed quantization processing.

However, a quantization processing having a higher seed has been currently desired. Thus, it is required to be able to carry out the quantization of a pixel following the pixel-of-interest immediately after the quantization of the pixel-of-interest. In order to realize this, when the quantization of the pixel-of-interest is completed (or simultaneously with or at a timing sooner than the quantization of the pixel-of-interest), the operation using the quantization result of the pixel-of-interest must be completed.

In view of the above, it is an objective the present invention to be able to use, immediately after the completion of the quantization of the pixel-of-interest, the operation result to carry out the quantization of the next pixel.

### SUMMARY OF THE INVENTION

In order to solve the above disadvantage, an apparatus according to the present invention is characterized in including: an N-valuing unit for N-valuing pixel data in the respective pixels included in an image to have a value of N (N is an integer of 2 or more) by using threshold values to the respective pixels to thereby obtain N-valuing results for the respective pixels; and a calculation unit for calculating threshold values to the respective pixels. The calculation unit performs, prior to the respective pixels, a processing for multiplying with a coefficient the respective N-valuing results of a plurality of pixels by the N-valuing performed by the N-valuing unit to calculate the sum to thereby calculate the threshold value, and the N-valuing performed by the N-valuing unit of pixel data of a specific pixel of the plurality of pixels is not after the processing by the calculation unit of multiplying with the coefficient of an N-valuing result of pixel data of the specific pixel.

The present invention can allow the processing required for executing the average density storage method on a hardware to be performed with a higher speed.

Further features of the present invention will become apparent from the following description of exemplary embodiments (with reference to the attached drawings).

### BRIEF DESCRIPTION OF THE DRAWINGS

FIG. 1 illustrates a pixel-of-interest, a range within which the weighted operation of the binarization result is performed, and a range within which the error distribution is performed in the first embodiment and a conventional technique;

FIG. 2 illustrates the coefficients when the weighted operation of the binarization result is performed in the first embodiment and the conventional technique;

FIG. 3 illustrates an example of binarization result in the first embodiment and the conventional technique;

FIG. 4 is a diagram showing the relationship of FIGS. 4A and 4B;

FIG. 4A illustrates hardware in the conventional technique;

FIG. 4B illustrates hardware in the conventional technique;

FIG. 5 illustrates a clock edge and the operation processing in the conventional technique;

FIG. 6 is a diagram showing the relationship of FIGS. 6A and 6B;

FIG. 6A illustrates hardware in the first embodiment;

FIG. 6B illustrates hardware in the first embodiment;

FIG. 7 illustrates the clock edges and the contents of the operation processing in the first embodiment;

FIG. 8 illustrates the pixel-of-interest, the range within which the weighted operation of the binarization result is performed, and the range within which the error distribution is performed in the second embodiment and the conventional technique;

FIG. 9 illustrates the coefficients when the weighted operation of the binarization result is performed in the second embodiment and the conventional technique;

FIG. 10 illustrates an example of the binarization result in the second embodiment and the conventional technique;

FIG. 11 is a diagram showing the relationship of FIGS. 11A and 11B;

FIG. 11A illustrates hardware in the conventional technique;

FIG. 11B illustrates hardware in the conventional technique;

FIG. 12 illustrates the clock edges and the contents of the operation processing in the conventional technique;

FIG. 13 is a diagram showing the relationship of FIGS. 13A and 13B;

FIG. 13A illustrates hardware in the second embodiment;

FIG. 13B illustrates hardware in the second embodiment;

FIG. 14 illustrates the clock edges and the contents of the operation processing in the second embodiment;

FIG. 15 illustrates a pixel-of-interest, a range within which the weighted operation of the four-valuing result is performed, and a range within which the error distribution is performed in the third embodiment and the conventional technique;

FIG. 16 illustrates the coefficients when the weighted operation of four-valuing result is performed in the third embodiment and the conventional technique;

FIG. 17 illustrates an example of the four-valuing result in the third embodiment and the conventional technique;

FIG. 18 is a diagram showing the relationship of FIGS. 18A and 18B;

FIG. 18A illustrates the hardware in the conventional technique;

FIG. 18B illustrates the hardware in the conventional technique;

FIG. 19 is a diagram showing the relationship of FIGS. 19A and 19B;

FIG. 19A illustrates the hardware in the third embodiment;

FIG. 19B illustrates the hardware in the third embodiment; and

FIG. 20 illustrates the clock edges and the contents of the operation processing in the third embodiment.

### DESCRIPTION OF THE EMBODIMENTS

A conventional average density storage method is a method for repeating the three processings of a threshold value calculation, a binarization processing, and an error distribution in the manner as described below.

In the threshold value calculation processing based on the average density storage method, the binarization result of pixels for which the binarization is already completed and which is followed by a pixel-of-interest is used to calculate the threshold value to the pixel-of-interest corresponding to the binarization result.

In the binarization processing of the average density storage method, the pixel-of-interest image data is subjected to error compensation based on the binarization error of the precedent pixels. Thereafter, the compensated value is compared with the threshold value calculated by the above-described threshold value calculation processing to thereby perform a binarization processing.

In the error distribution processing based on the average density storage method, an error caused in the binarization (a difference between the threshold value and the image data after the error compensation) are subsequently given as an error compensation value to the to-be-processed image data.

The following section will describe the respective processings of the conventional average density storage method.

### <Threshold Value Calculation Processing by Conventional Average Density Storage Method>

When assuming that a pixel-of-interest as a target of the binarization processing is (n,m), then the pixels before n−1 in the line m are already subjected to a binarization processing and thus the binary image data (“1” or “0”) exists. In this case, (n,m) denotes the positions of the pixels. For example, n represents a position in the main scanning direction in a recording apparatus and m represents a position in the sub-scanning direction in the recording apparatus.

Similarly, the lines before m−1 are also subjected to the binarization processing and have binary image data.

In the threshold value calculation processing, the binarization result of the pixels before the pixel-of-interest for which the binarization processing is already completed is subjected to the weighted operation to thereby calculate a threshold value of the pixel-of-interest.

Here, the weighted operation is a operation for performing a processing in which a plurality of pieces of pixel data are multiplied with a previously-set coefficient to calculate the sum of them.

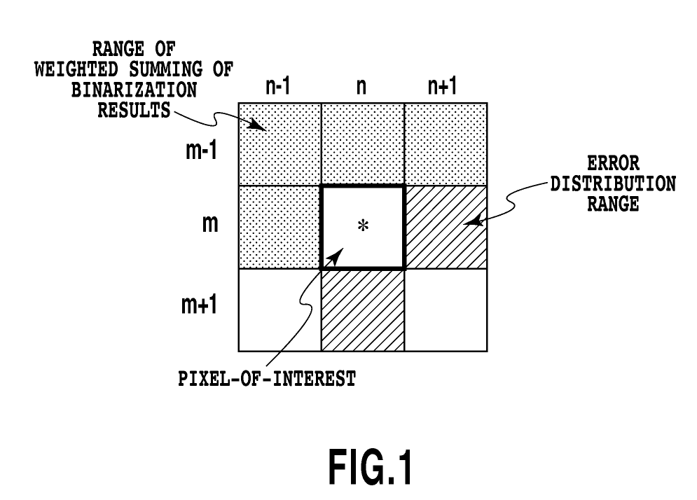

The following section will describe, with reference to FIG. 1, the threshold value calculation processing based on the average density storage method.

In FIG. 1, the range of pixels used for the threshold value calculation is 4 pixels of (n−1,m−1), (n,m−1), (n+1,m−1), and (n−1,m).

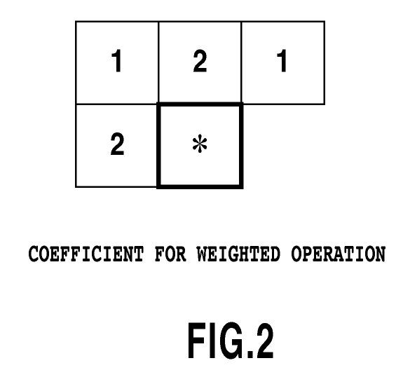

FIG. 2 illustrates weighting coefficients to the above 4 pixels. As shown in FIG. 2, the pixel (n−1,m−1) corresponds to a weighting coefficient of “1”. The pixel (n,m−1) correspond to a weighting coefficient of “2”. The pixel (n+1,m−1) corresponds to a weighting coefficient of “1”. The pixel (n−1,m) correspond to a weighting coefficient of “2”.

Here, the binarization processing result before the pixel-of-interest is subjected to the weighted operation processing based on an assumption that a value of a part for outputting a color is “the Max value of the image data” (e.g., “255”) and a value of a part for not outputting a color is “0”.

Thus, the threshold value SL (n,m) to the pixel-of-interest (n,m) is calculated by performing the weighted operation processing as described below.

First, in the weighted operation processing, the multiplication with the coefficients of the respective pixels is performed in the manner as shown below.

The weighting coefficient of S(n−1,m−1)=(n−1,m−1)×the binarization processing result value of (n−1,m−1)×the Max value of the image data

The weighting coefficient of S(n,m−1)=(n,m−1)×the binarization processing result value of (n,m−1)−the Max value of the image data

The weighting coefficient of S(n+1,m−1) (n+1,m−1)×the binarization processing result value of (n+1,m−1)×the Max value of the image data

The weighting coefficient of S(n−1,m)=(n−1,m)×the binarization processing result value of (n−1,m)×the Max value of the image data

Next, the weighted operation processing calculates the sum of the multiplication results of the respective pixels in the manner as shown below.

Ssum(n,m)=S(n−1,m−1)+S(n,m−1)+S(n+1,m−1)+S(n−1,m)

Next, the weighted operation processing compensates the sum of the above multiplication results in the manner as shown below.

SL(n,m)=Ssum(n,m)/{the weighting coefficient of (n−1,m−1)+the weighting coefficient of (n,m−1)+the weighting coefficient of (n+1,m−1)+the weighting coefficient of (n−1,m)}

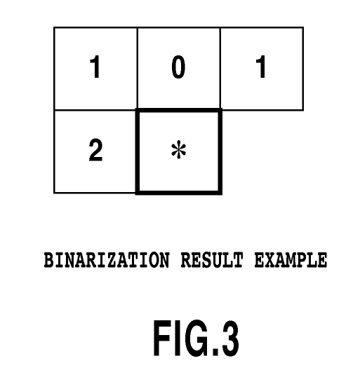

Thus, when the binarization processing result before the pixel-of-interest is as shown in FIG. 3, the threshold value SL(n,m) to the pixel-of-interest (n,m) is calculated by the weighted operation processing as shown below.

SL(n,m)={(1×1×255)+(2×0×255)+(1×1×55)+(2×1×255)}/(1+2+1+2)=170

### <Binarization Processing of Conventional Average Density Storage Method>

Next, the pixel-of-interest image data is subjected to the error compensation based on the binarization error of the precedent pixel and is then compared with the threshold value to perform a binarization processing.

In the binarization processing, as shown in FIG. 1, an error is distributed to a pixel following the pixel-of-interest in the line of the pixel-of-interest and the same position as that of the pixel-of-interest in a line one line lower than the pixel-of-interest line. Thus, the error data from the pixel one pixel before the pixel-of-interest in the pixel-of-interest line and the error data from the pixel that is at the same position in the line one line before the pixel-of-interest are added to the input data of the pixel-of-interest.

Here, the input data of the pixel-of-interest (n,m) is assumed as Din(n,m) and the binarization processing error data for the pixel one pixel before the pixel-of-interest in the pixel-of-interest line is assumed as Er(n−1,m). The binarization processing error data of the pixel that is in the line one line before the pixel-of-interest and that is at the same position as that of the pixel-of-interest is assumed as Ed(n,m−1). Then, the pixel-of-interest image data after error compensation D(n,m) is calculated by the operation as shown below.

D(n,m)=Din(n,m)+Er(n−1,m)+Ed(n,m−1)

For example, in the case of Din(n,m)=120, Er(n−1,m)=14, and Ed(n,m−1)=−8, then D(n,m), which is the data after the error compensation, is a value as shown below.

D(n,m)=120+14+(−8)=126

The error data Er and Ed will be described later.

Next, D(n,m) is compared with SL(n,m) that is the previously-calculated threshold value corresponding to the pixel-of-interest. Then, a judgment as to whether a color is outputted or not to the pixel-of-interest is performed in the manner as shown below to thereby determine Bin(n,m) that is an output of the binarization result.

In the case of D(n,m)≧SL(n,m) for example, it is judged that a color is outputted and Bin(n,m)=1 is determined. In the case of D(n,m)<SL(n,m) on the other hand, no color is outputted and Bin(n,m)=0 is determined.

In the above-described example for example, D(n,m)=126 and SL(n,m)=170 are established. Thus, “D(n,m)<SL(n,m)” is established and it is judged that no color is outputted for the pixel-of-interest. Thus, Bin(n,m)=0 is determined.

### <Error Distribution Processing of Conventional Average Density Storage Method>

Next, in the conventional average density storage method, a difference between the threshold value SL(n,m) and the image data after the error compensation D(n,m) is assumed as a binarization error E(n,m) and is distributed to the subsequent processing pixels.

E(n,m)=SL(n,m)−D(n,m)

In the error distribution processing, as shown in FIG. 1, a pixel in the pixel-of-interest line at a position moved to the right side of the pixel-of-interest by one pixel and a pixel in the pixel-of-interest line at a position one line lower than the pixel-of-interest are subjected to the error data distribution.

Here, the error data distributed to the pixel in the pixel-of-interest line at a position moved to the right side of the pixel-of-interest by one pixel is assumed as Er(n,m) and the error data distributed to the pixel that is at a position one line lower than the pixel-of-interest and that is at the same position as that of the pixel-of-interest is assumed as Ed(n,m). Then, ½ of E(n,m) is distributed to the two parts of the pixel in the pixel-of-interest line at a position moved to the right side of the pixel-of-interest by one pixel and the pixel in the pixel-of-interest line at a position moved to the lower side by one pixel, respectively.

In this case, Er(n,m)=E(n,m)/2 and Ed(n,m)=E(n,m)/2 are established.

For example, in the above-described example, D(n,m)=126 and SL(n,m)=170 are established. Thus, E(n,m)−SL(n,m)−D(n,m)=170−126=44 is calculated. Then, Er(n,m)=E(n,m)/2=44/2=22 and Ed(n,m)=E(n,m)/2=4412=22 are established.

The above Er(n,m) is used for the error compensation of Din(n+1,m). Ed(n,m) is used for the error compensation of Din(n,m+1).

### <Hardware for Carrying Out Conventional Average Density Storage Method>

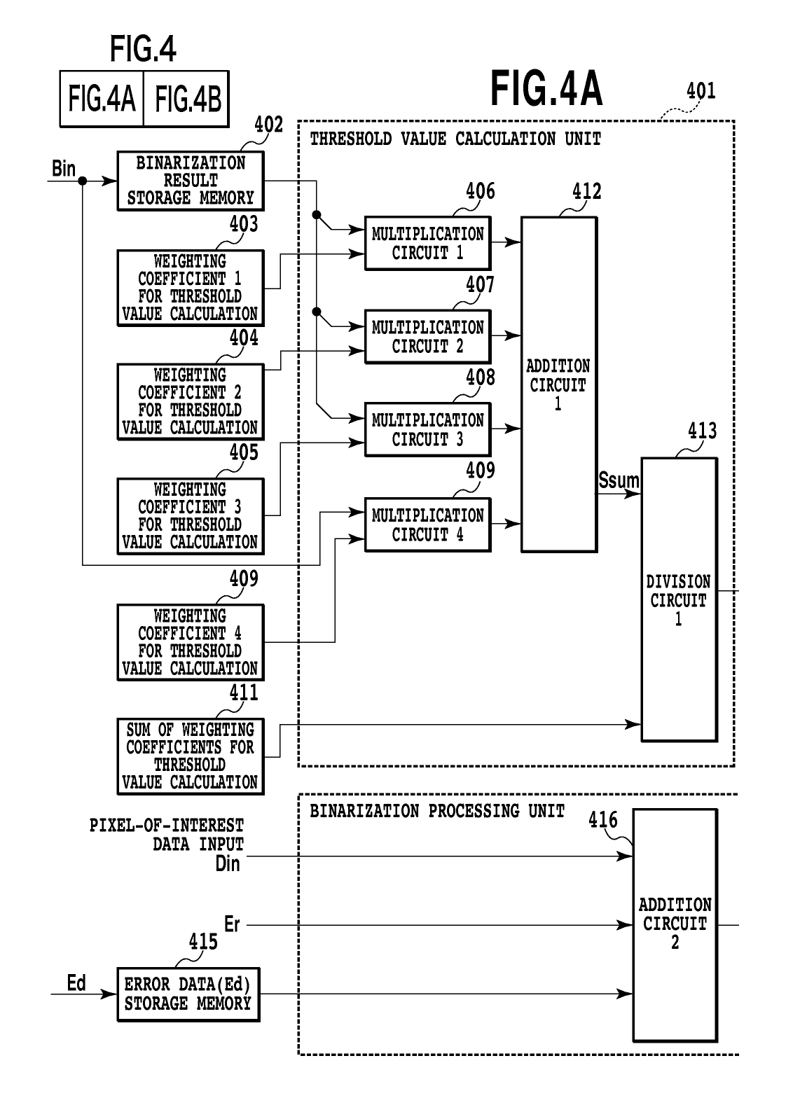

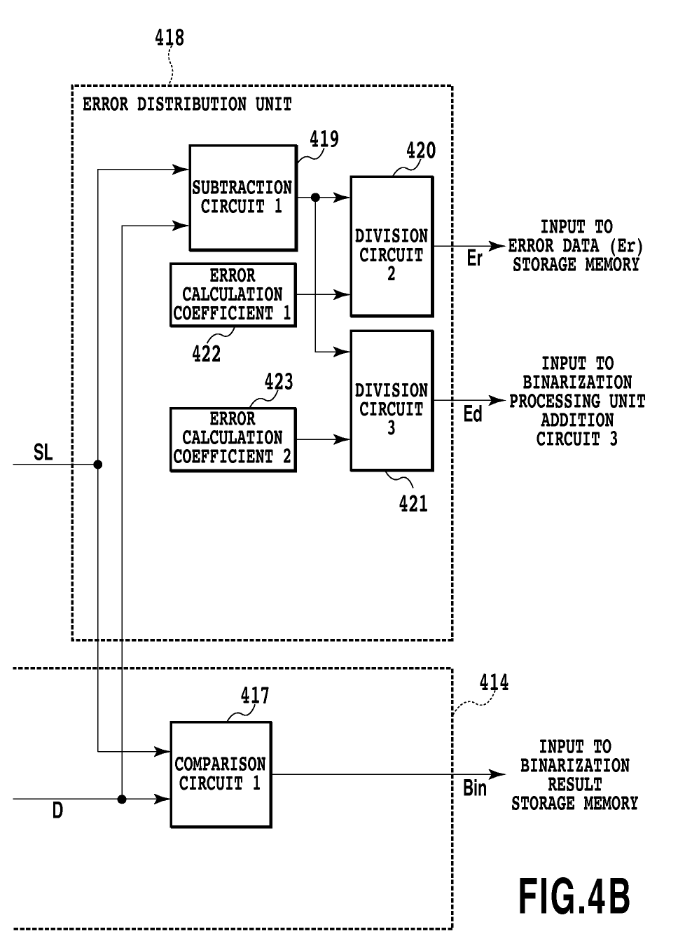

Next, the hardware for carrying out the conventional average density storage method will be described with reference to FIG. 4. As shown in FIG. 4, the hardware for carrying out the conventional average density storage method has: a threshold value calculation unit 401; a binarization processing unit 414; and an error distribution unit 418.

### <Threshold Value Calculation Unit 401)

The following section will describe the threshold value calculation unit 401 of FIG. 4.

Regarding the line m−1 around the pixel-of-interest (n,m) of FIG. 1, the binarization processing is already completed and the binarized image data exists.

These pieces of binarized image data are stored in a binarization result storage memory 402.

The threshold value calculation unit 401 performs a weighted operation on the image data already subjected to the binarization processing stored in the binarization result storage memory 402 to calculate the threshold value of the pixel-of-interest.

The Weighting coefficient 1 for threshold value calculation (403) of FIG. 4 stores a weighting coefficient to the pixel (n−1,m−1).

The Weighting coefficient 2 for threshold value calculation (404) of FIG. 4 stores a weighting coefficient to the pixel (n,m−1).

The Weighting coefficient 3 for threshold value calculation (405) of FIG. 4 stores a weighting coefficient to the pixel (n+1,m−1).

The Weighting coefficient 4 for threshold value calculation (409) of FIG. 4 stores a weighting coefficient to the pixel (n−1,m).

The sum (411) of the weighting coefficient for threshold value calculation of FIG. 4 stores the sum of the weighting coefficients to the pixels (n−1,m−1), (n,m−1), (n+1,m−1), and (n−1,m).

The threshold value calculation unit 401 of FIG. 4 causes the binarization result storage memory 402 to output the binarized image data of the 3 pixels of (n−1,m−1), (n,m−1), and (n+1,m−1).

Then, a multiplication circuit 1 (406) subjects the binarized image data of the pixel (n−1,m−1) to the multiplication of the weighting coefficient of (n−1,m−1) with the Max value of the image data.

A multiplication circuit 2 (407) subjects the binarized image data of the pixel (n,m−1) to the multiplication of the weighting coefficient of (n,m−1) with the Max value of the image data.

A multiplication circuit 3 (408) subjects the binarized image data of the pixel (n+1,m−1) to the multiplication of the weighting coefficient of (n+1,m−1) with the Max value of the image data.

The threshold value calculation unit 401 directly inputs, as the binarized image data of the pixel (n−1,m), the binarization result Bin(n,m) outputted in the previous binarization processing to a multiplication circuit 4 (410). Then, the multiplication circuit 4 (410) performs the multiplication of the weighting coefficient of the pixel (n−1,m) stored in the Weighting coefficient 4 for threshold value calculation (409) with the Max value of the image data.

Then, the threshold value calculation unit 401 outputs the output values from the multiplication circuit 1 (406), the multiplication circuit 2 (407), the multiplication circuit 3 (408), and the multiplication circuit 4 (410) to the addition circuit 1 (412) to calculate Ssum(n,m).

Then, the threshold value calculation unit 401 causes the division circuit 1 (413) to divide Ssum(n,m) outputted from the addition circuit 1 (412) by the value of the sum of the weighting coefficients stored in the weighting coefficient for threshold value calculation sum 411 to thereby calculate SL(n,m) that is the threshold value to the pixel-of-interest.

### <Binarization Processing Unit 414>

The binarization processing unit 414 compares, with regard to the pixel-of-interest image data, D(n,m) subjected to the error compensation based on the binarization error of the precedent pixel with the threshold value SL(n,m) calculated by the threshold value calculation unit 401 to thereby perform a binarization processing.

The addition circuit 2 (416) of the binarization processing unit 414 of FIG. 4 receives the input data Din(n,m) of the pixel-of-interest (n,m) and the error data Er(n−1,m) (which will be described later) that is outputted from the error distribution unit 418 and that is calculated by the binarization processing to the pixel one pixel before the pixel-of-interest.

The error data (Ed) storage memory 415 stores, among the binarization error of the pixels before the pixel-of-interest, the binarization processing error data Ed(n,m−1) of the pixel that is in the line one line before the pixel-of-interest and that is at the same position as that of the pixel-of-interest.

The error data Er and Ed will be described later.

As shown in FIG. 4, the binarization processing unit 414 receives the following three pieces of data. Specifically, Din(n,m), Er(n−1,m), and Ed(n,m−1) are inputted to the binarization processing unit 414.

The addition circuit 2 (416) of the binarization processing unit 414 adds the three pieces of Din(n,m), Er(n−1,m), and Ed(n,m−1) to calculate the data D(n,m) after the error compensation of the pixel-of-interest.

Next, a comparison circuit 1 (417) of the binarization processing unit 414 compares the data D(n,m) after the error compensation of the pixel-of-interest with the threshold value SL(n,m) to the pixel-of-interest calculated by the threshold value calculation unit 401. Then, the comparison circuit 1 (417) of the binarization processing unit 414 judges whether to output a color to the pixel-of-interest (Bin (n,m)=1) or not to output a color (Bin (n,m)=0) to output the binarization result.

The comparison circuit 1 (417) judges whether Bin(n,m)=1 or Bin(n,m)=2 in the manner as shown below. Specifically, in the case of D(n,m)≧SL(n,m), the comparison circuit 1 (417) judges that a color is outputted to determine Bin (n,m)=1. In the case of D(n,m)<SL(n,m) on the other hand, the comparison circuit 1 (417) judges not to output a color to judge Bin(n,m)=0.

Bin(n,m), which is a binarization result of the pixel-of-interest outputted from the comparison circuit 1 (417), is inputted to the binarization result storage memory 402 and the multiplication circuit 4 (410) of the threshold value calculation unit 401, respectively.

The data Bin(n,m) stored in the binarization result storage memory 402 is used to calculate a threshold value for the binarization processing to a line next to the line already subjected to the binarization processing.

The data Bin(n,m) inputted to the multiplication circuit 4 (410) of the threshold value calculation unit 401 is used to calculate a threshold value for the binarization processing of a pixel next to the pixel already subjected to the binarization processing.

### <Error Distribution Unit 418>

The error distribution unit 418 distributes a difference between SL(n,m) as the threshold value of the pixel-of-interest calculated by the threshold value calculation unit 401 and D(n,m) as the data after the error compensation of the pixel-of-interest as the binary error E(n,m) to a to-be-processed pixel.

First, a subtraction circuit 1 (419) of the error distribution unit 418 calculates E(n,m) that is a difference between SL(n,m) as the threshold value of the pixel-of-interest calculated by the threshold value calculation unit 401 and D(n,m) as the data after the error compensation of the pixel-of-interest.

In the processing carried out by the error distribution unit 418, as shown in FIG. 1, the pixel in the pixel-of-interest line at a position moved to the right side of the pixel-of-interest by one pixel and the pixel that is in a line one line lower than the pixel-of-interest line and that is at the same position as that of the pixel-of-interest are subjected to an error data distribution.

Here, it is assumed that the error data to the pixel in the line of the pixel-of-interest (n,m) at a position moved to the right side of the pixel-of-interest by one pixel is Er(n,m) and the error data to the pixel that is in a line one line lower than the line of the pixel-of-interest (n,m) and that is at the same position as that of the pixel-of-interest is Ed(n,m). Then, the error data is distributed to the respective pixels at the right side and at the lower side of the pixel-of-interest (n,m).

The error data Er(n,m) distributed to the pixel in the line of the pixel-of-interest (n,m) at a position moved to the right side of the pixel-of-interest by one pixel is calculated by a division circuit 2 (420).

The error data Er(n,m) distributed to the pixel that is at the same position as that of the pixel-of-interest (n,m) and that is at a position one line lower than the pixel-of-interest line is calculated by a division circuit 3 (421).

Here, an error calculation coefficient 1 (422) stores a coefficient used to calculate Er(n,m) based on the binarization error E(n,m). The coefficient used to calculate Er(n,m) based on the binarization error E(n,m) is read from the error calculation coefficient 1 (422) and is inputted to the division circuit 2 (420).

An error calculation coefficient 2 (423) also stores a coefficient used to calculate Ed(n,m) from the binarization error E(n,m). The coefficient used to calculate Ed(n,m) from the binarization error E(n,m) is read from the error calculation coefficient 2 (423) is inputted to the division circuit 3 (421).

The error data Ed(n,m) to the pixel in the line of the pixel-of-interest (n,m) at a position one line lower than the pixel-of-interest and at the same position as that of the pixel-of-interest is stored in the storage memory 415.

The error data Er(n,m) to the pixel in the line of the pixel-of-interest (n,m) at a position moved to the right side of the pixel-of-interest by one pixel is inputted to an addition circuit 2 (416) of the binarization processing unit 414.

The error data (Ed(n,m)) stored in an error data (Ed) storage memory 415 is used for the error compensation by the binarization processing unit 414 for the binarization processing of the line next to the line of the pixel-of-interest (n,m).

The error data (Er(n,m)) inputted to the addition circuit 2 (416) of the binarization processing unit 414 is used for the error compensation by the binarization processing unit 414 for the pixel following the pixel-of-interest (n,m).

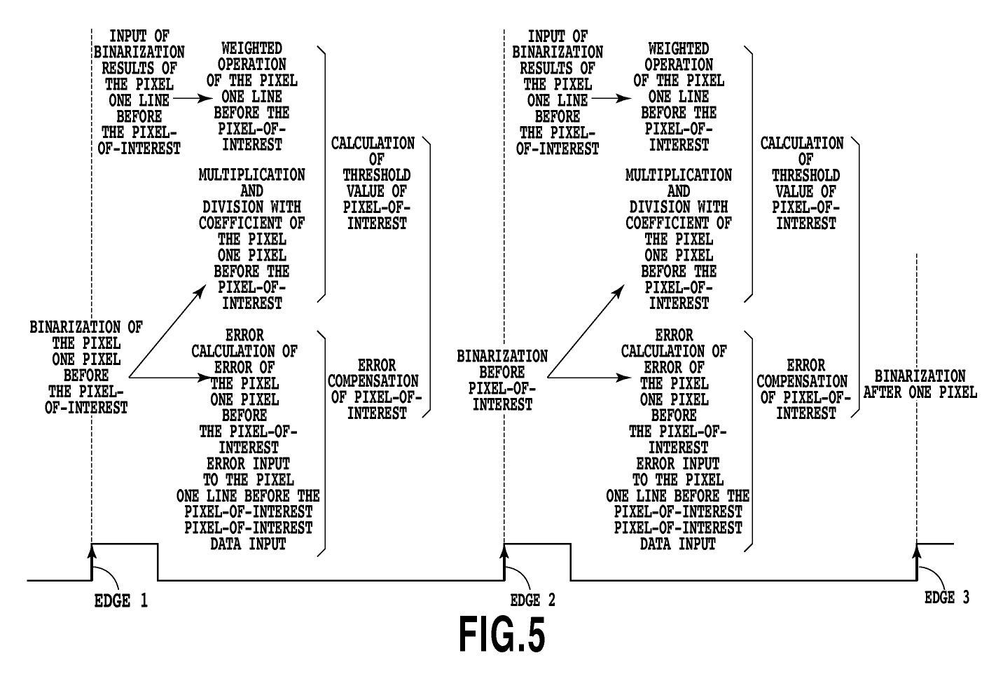

Next, with reference to FIG. 5, the following section will describe an order of the respective processings to clock edges.

When the pixel-of-interest is binarized at a rising of a clock edge 2, the processing shown in FIG. 5 is performed.

At the rising of the clock edge 1, the binarization of the pixel one pixel before the pixel-of-interest is completed and, at the same timing as that of the output of the binary data, the binarization of the pixel one line before the pixel-of-interest is inputted that is inputted from the binarization result storage memory 402 and that is used to calculate the threshold value of the pixel-of-interest.

Then, based on the binarization of the pixel one line before the pixel-of-interest, an area one line before the pixel-of-interest is subjected to a weighted operation.

At the same time, the result of the binarization of the pixel one pixel before the pixel-of-interest is multiplied with the coefficient for the pixel one pixel before the pixel-of-interest. Based on the result thereof and the weighted operation result of the area one line before the pixel-of-interest, the threshold value to the pixel-of-interest is calculated.

In parallel with the above processing, Din(n,m) is subjected to the error compensation to the pixel-of-interest based on Er(n−1,m) and Ed(n,m−1) inputted from the error data (Ed) storage memory 415.

Then, the threshold value SL(n,m) to the pixel-of-interest calculated by the above processing is compared with the error compensation data D(n,m) for the pixel-of-interest. Then, the pixel-of-interest is binarized at the rising of the clock edge 2 and the result is outputted from the binarization processing unit 414.

Thereafter, at the next edge 3, the pixel one pixel after the pixel-of-interest is subjected to the same processing as a pixel-of-interest.

As described above, in order to output the processing result of the average density storage method with a pace of one pixel for one clock, it is required to complete all of the threshold value calculation processing, the binarization processing, and the error distribution processing within one clock.

Specifically, it is required to complete all of the threshold value calculation unit 401, the binarization processing unit 414, and the error distribution unit 418 of FIG. 4 within one clock.

Thus, Japanese Laid-Open Patent publication No. H11-136511 (1999) for example suggests a processing method by which the operation processing of the pixel one pixel before the pixel-of-interest and the operation processing of the other pixels are separately allocated to two operation units so that a operation that can be performed in advance is performed in advance.

Currently, an improved image quality causes an increased gray level number of image data causing an increased bit number of image data, an expanded area for the weighted operation processing for the threshold value calculation, and an expanded area for the error distribution for example, thus causing an increased operational load required for the average density storage method than in the conventional technique.

Due to this reason, when an operation at an early frequency is to be performed, various operation processings required for the average density storage method are not completed within one clock, thus preventing the average density storage method from being performed at a high speed.

Thus, it is an objective of the present invention to reduce the load of the operation carried out by the average density storage method to the pixel-of-interest to thereby allow the processing required for the average density storage method to have a higher speed.

### First Embodiment

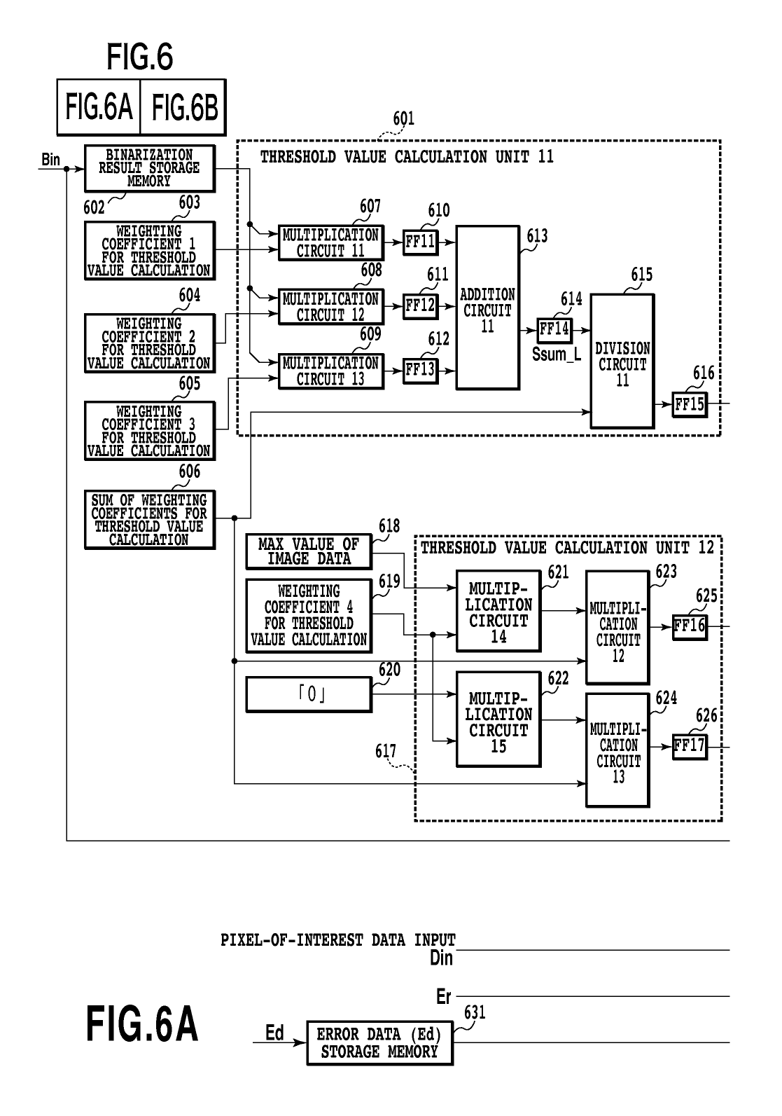

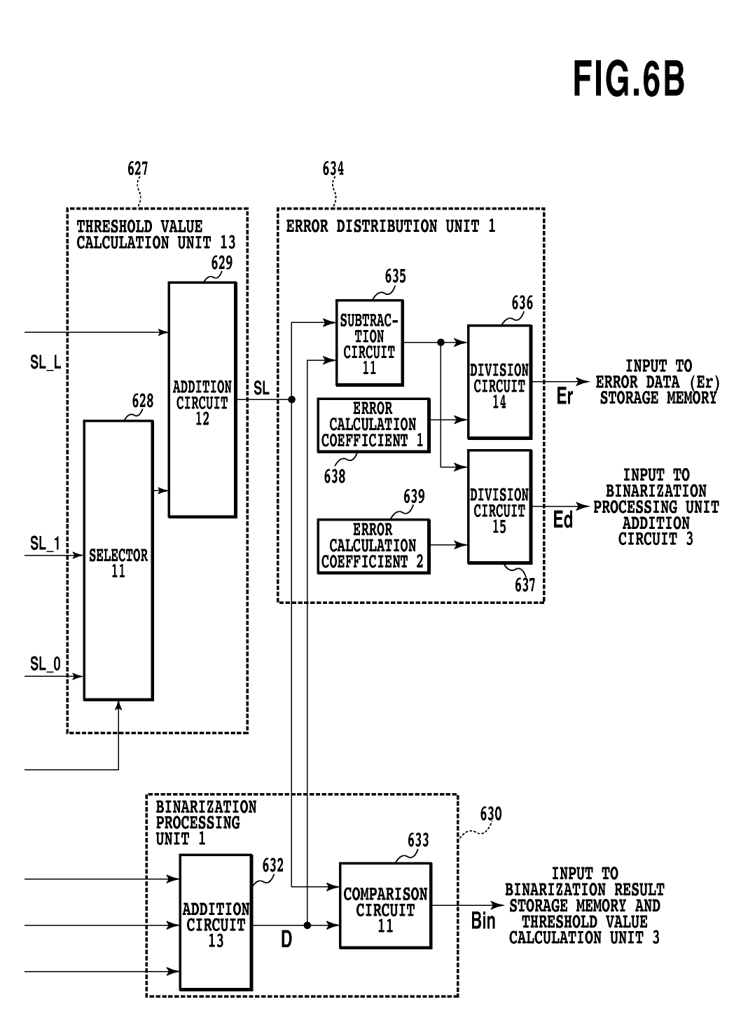

Hardware realizing the average density storage method in the first embodiment is shown in FIG. 6.

### <Threshold Value Calculation Unit 11 (601)>

The following section will describe the first embodiment based on an assumption that the line m−1 is already subjected to the binarization processing and the binary image data exists and the binary image data is stored in a binarization result storage memory 602.

A threshold value calculation unit 11 (601) subjects, to the weighted operation, the binarization result of the pixels before the pixel-of-interest for which the binarization processing is completed. In particular, the line before the pixel-of-interest are subjected to the weighted operation.

In the present invention, the pixel-of-interest is a specific pixel among a plurality of pixels.

In the present invention, the weighted operation is a operation in which a plurality of pieces of pixel data are multiplied with a previously-set coefficient to calculate the sum thereof.

The following section will describe in detail the first embodiment with reference to FIG. 6.

A Weighting coefficient 1 for threshold value calculation (603) stores therein a weighting coefficient (n−1,m−1) by a memory for example.

A Weighting coefficient 2 for threshold value calculation (604) stores therein a weighting coefficient (n,m−1) by a memory for example.

A Weighting coefficient 3 for threshold value calculation (605) stores therein a weighting coefficient (n+1,m−1) by a memory for example.

The weighting coefficient herein is a coefficient used in the weighted operation (which will be described later).

The weighting coefficient for threshold value calculation sum (606) stores therein, by a memory for example, the sum of the weighting coefficients (n−1,m−1), (n,m−1), (n+1,m−1), and (n−1,m).

Next, the multiplication circuit 11 (607) receives, from a binarization result storage memory (602), the binarized data for the pixel (n−1,m−1) to multiply the binarized data, the weighting coefficient of (n−1,m−1), and the Max value of the image data to thereby output the result. Here, the Max value of the image data is “255” for example.

A multiplication circuit 12 (608) receives the binarized data for the pixel (n,m−1) from the binarization result storage memory (602) and multiplies the binarized data, the weighting coefficient of (n,m−1), and the Max value of the image data (e.g., “255”) to thereby output the result.

A multiplication circuit 13 (609) receives the binarized data for the pixel (n+1,m−1) from the binarization result storage memory (602) and multiplies the binarized data, the weighting coefficient of (n+1,m−1), and the Max value of the image data to output the result. Here, the Max value of the image data is “255” for example.

Next, an addition circuit 11 (613) receives, via the FF11 (610), the output value from the multiplication circuit (607).

The addition circuit 11 (613) also receives, via the FF12 (611), the output value from the multiplication circuit 12 (608).

The addition circuit 11 (613) also receives, via the FF13 (612), the output value from the multiplication circuit 13 (609).

Then, the addition circuit 11 (613) adds the output value from the multiplication circuit 11 (607), the output value from the multiplication circuit 12 (608), and the output value from the multiplication circuit 13 (609) to calculate the sum (Ssum_L) of the respective pixels of the line before the pixel-of-interest to thereby output the result.

Next, the division circuit 11 (615) receives, via an FF14 (614), the output value (Ssum_L) from the addition circuit 11 (613) to receive the value stored in the weighting coefficient for threshold value calculation sum (606). Then, the division circuit 11 (615) divides Ssum_L by the value stored in the weighting coefficient for threshold value calculation sum (606) to calculate the threshold value (S_L(n,m)) corresponding to the pixel-of-interest that is one line before the pixel-of-interest to thereby output the result. The operation as described above is a weighted operation performed by the threshold value calculation unit 11 (601).

### <Threshold Value Calculation Unit 12 (617) and the Threshold Value Calculation Unit 13 (627)>

The threshold value calculation unit 12 (617) performs the operation of a coefficient with the binarization result of the pixels before the pixel-of-interest for which the binarization processing is completed. In particular, the threshold value calculation unit 12 (617) performs the operation of the binarization result of the pixel one pixel before the pixel-of-interest.

The threshold value calculation unit 12 (617) assumes two cases of a case where, prior to the completion of the binarization processing of the pixel one pixel before the pixel-of-interest, the pixel one pixel before the pixel-of-interest has a binarization processing result of “1” and a case where, prior to the completion of the binarization processing of the pixel one pixel before the pixel-of-interest, the pixel one pixel before the pixel-of-interest has a binarization processing result of “0”. The threshold value calculation unit 12 (617) performs in advance the multiplication and division of the pixel one pixel before the pixel-of-interest with a coefficient.

In this embodiment, SL_{—}1 (n,m) is assumed as the result of the multiplication and division with the coefficient when the pixel one pixel before the pixel-of-interest has a binarization processing result of “1”. In this embodiment, SL_{—}0 (n,m) is assumed as the result of the multiplication and division with the coefficient when the pixel one pixel before the pixel-of-interest has a binarization processing result of “9”.

Thereafter, the threshold value calculation unit 13 (627) selects, at the timing at which the pixel one pixel before the pixel-of-interest obtains its binarization processing result, SL_{—}1 (n,m) or SL_{—}0 (n,m) based on the output thereof. Then, the threshold value calculation unit 13 (627) adds it to the threshold value to the pixel-of-interest (SL_L(n,m)) calculated in advance for the line before the pixel-of-interest to calculate the threshold value SL(n,m) corresponding to the pixel-of-interest.

The following section will describe in detail, with reference to FIG. 6, the threshold value calculation unit 12 (617) and the threshold value calculation unit 13 (627).

A Weighting coefficient 4 for threshold value calculation (619) stores therein the weighting coefficient of (n−1,m) by a memory for example.

The weighting coefficient for threshold value calculation sum (606) stores therein the sum of the weighting coefficient of (n−1,m) by a memory for example.

A multiplication circuit 14 (621) multiplies the Max value of the image data 618 with the weighting coefficient of (n−1,m) stored in the Weighting coefficient 4 for threshold value calculation (619).

Thereafter, a division circuit 12 (623) divides the result of the multiplication with the coefficient for the pixel one pixel before the pixel-of-interest outputted from the multiplication circuit 14 (621) by the value stored in the weighting coefficient for threshold value calculation sum (606). Then, the division circuit 12 (623) calculates, based on this operation, the threshold value SL_{—}1(n,m) corresponding to the pixel-of-interest the pixel one pixel before the pixel-of-interest.

A multiplication circuit 15 (622) multiplies the minimum value (620) of the image data (“0” in this embodiment) with the weighting coefficient of (n−1,m) stored in the Weighting coefficient 4 for threshold value calculation (619).

Thereafter, a division circuit 13 (624) divides the multiplication result of the pixel one pixel before the pixel-of-interest outputted from the multiplication circuit 15 (622) by the value stored in the weighting coefficient for threshold value calculation sum (606). Then, the division circuit 13 (624) calculates, based on this operation, the threshold value (SLO(n,m)) corresponding to the pixel-of-interest the pixel one pixel before the pixel-of-interest.

The threshold value calculation unit 13 (627) has a the selector 11 (628) and an addition circuit 12 (629).

The selector 11 (628) selects, based on the binarization result of the pixel one pixel before the pixel-of-interest, SL_{—}1 (n,m) or SL_{—}0(n,m) outputted from the threshold value calculation unit 12 (617) to input the value to the addition circuit 12 (629).

The addition circuit 12 (629) adds the SL_L(n,m) calculated in advance to the threshold value SL_{—}1 (n,m) or SL_{—}0 (n,m) of the pixel-of-interest the pixel one pixel before the pixel-of-interest outputted from a selector 11. Then, the addition circuit 12 (629) calculates, based on this operation, the threshold value SL(n,m) to the pixel-of-interest to output the result to an error distribution unit 1 (634).

### <Binarization Processing Unit 1 (630)>

The binarization processing unit 1 (630) compares the data (D(n,m)) after the error compensation of the pixel-of-interest with the threshold value SL(n,m) calculated by the threshold value calculation unit 13 (627) to perform a binarization processing.

Er(n−1,m) is error data that is outputted from the error distribution unit 1 (634) (which will be described later) and that is calculated based on the binarization result of the pixel one pixel before the pixel-of-interest.

An error data (Ed) storage memory (631) stores the error data regarding Ed(n,m−1) among the binarization error of the pixels before the pixel-of-interest.

The error data Er and Ed will be described later.

The binarization processing unit 1 (630) receives the following three pieces of data as shown in FIG. 6.

Specifically, Din(n,m), Er(n−1,m), and Ed(n,m−1) are inputted to the binarization processing unit 1 (630). Here, Din(n,m) is the input data of the pixel-of-interest. Er(n−1,m) is the binarization processing error data for the pixel one pixel before the pixel-of-interest in the pixel-of-interest line. Ed(n,m−1) is binarization processing error data for the pixel that is the line one line before the pixel-of-interest and that is at the same position as that of the pixel-of-interest.

An addition circuit 13 (632) adds the above three pieces of data to calculate the data D(n,m) after the error compensation of the pixel-of-interest.

Next, the comparison circuit 11 (633) of the binarization processing unit 1 (630) compares the data D(n,m) after the error compensation of the pixel-of-interest with the threshold value SL(n,m) to the pixel-of-interest calculated by the threshold value calculation unit 13 (627). Then, the comparison circuit 11 (633) judges as to whether a color is outputted to the pixel-of-interest (Bin(n,m)=1) or no color is outputted (Bin(n,m)=0) to output the binarization result.

The comparison circuit 11 (633) judges Bin(n,m)=1 or Bin (n,m)=2 in the manner as shown below. Specifically, in the case of D(n,m)≧SL(n,m), the comparison circuit 11 (633) judges that a color is outputted to judge Bin(n,m)=1. In the case of D(n,m)<SL(n,m) on the other hand, the comparison circuit 11 (633) judges that no color is outputted to judge Bin(n,m)=0.

Bin(n,m) outputted from the comparison circuit 11 (633), which is the binarization result of the pixel-of-interest, is inputted to the binarization result storage memory 602 and the selector 11 (628) of the threshold value calculation unit 13 (627), respectively.

The data stored in the binarization result storage memory (602) is used for the calculation of the threshold value for the binarization processing of a line following the line already subjected to the binarization processing.

The data inputted to the selector 11 (628) of the threshold value calculation unit 13 (627) is used for the calculation of the threshold value for the binarization processing of a pixel following the pixel already subjected to the binarization processing.

### <Error Distribution Unit 1 (634)>

The error distribution unit 1 (634) assumes a difference between the threshold value SL(n,m) of the pixel-of-interest calculated by the threshold value calculation unit 13 (627) and the data D(n,m) after the error compensation of the pixel-of-interest as the binarization error E(n,m) to distribute the binarization error E(n,m) to the to-be-processed pixel.

First, the subtraction circuit 11 (635) of the error distribution unit 1 (634) calculates E(n,m) that is a difference between the threshold value SL(n,m) of the pixel-of-interest calculated by the threshold value calculation unit 13 (627) and the data D(n,m) after the error compensation of the pixel-of-interest.

In the processing performed by the error distribution unit 1 (634), as shown in FIG. 1, the error data is distributed to the pixel in the pixel-of-interest line at a position moved to the right side of the pixel-of-interest by one pixel and the pixel that is at a position one line lower than the pixel-of-interest and that is at the same position as that of the pixel-of-interest.

Here, it is assumed that the error data distributed to the pixel in the line of the pixel-of-interest (n,m) at a position moved to the right side of the pixel-of-interest by one pixel is Er(n,m) and the error data distributed to the pixel at a position one line lower than the pixel-of-interest (n,m) and that is at the same position as that of the pixel-of-interest is Ed(n,m). Then, the error data is distributed to the respective pixels at the right side and the lower side of the pixel-of-interest (n,m).

The error data Er(n,m) distributed to the pixel in the line of the pixel-of-interest (n,m) at a position moved to the right side of the pixel-of-interest by one pixel is calculated by a division circuit 14 (636).

The error data Ed(n,m) distributed to the pixel at a position one line lower than the pixel-of-interest (n,m) and that is at the same position as that of the pixel-of-interest is calculated by a division circuit 15 (637).

Here, an error calculation coefficient 1 (638) stores therein, by a memory for example, a coefficient used for the calculation of Er(n,m) based on the binarization error E(n,m) (“½” in this embodiment). The coefficient used for the calculation of Er(n,m) based on the binarization error E(n,m) is read from the error calculation coefficient 1 (638) and is inputted to the division circuit 14 (636).

The error calculation coefficient 2 (639) stores therein, by a memory for example, a coefficient used for the calculation of Ed(n,m) based on the binarization error E(n,m) (“½” in this embodiment). The coefficient used for the calculation of Ed(n,m) based on the binarization error E(n,m) is read from the error calculation coefficient 2 (639) and is inputted to the division circuit 15 (637).

The error data Ed(n,m) distributed to the pixel at a position one line lower than the pixel-of-interest (n,m) and that is at the same position as that of the pixel-of-interest is inputted to an error data (Ed) storage memory 631.

The error data Er(n,m) distributed to the pixel in the line of the pixel-of-interest (n,m) at a position moved to the right side of the pixel-of-interest by one pixel is inputted to the addition circuit 13 (632) of the binarization processing unit 1 (630).

The error data (Ed(n,m)) stored in the error data (Ed) storage memory 631 is used for the error compensation in the binarization processing unit 1 (630) for the binarization processing of the line following the line of the pixel-of-interest (n,m).

The error data (Er(n,m)) inputted to the addition circuit 13 (632) of the binarization processing unit 1 (630) is used for the error compensation in the binarization processing unit 1 (630) for the binarization processing of the pixel following the pixel-of-interest (n,m).

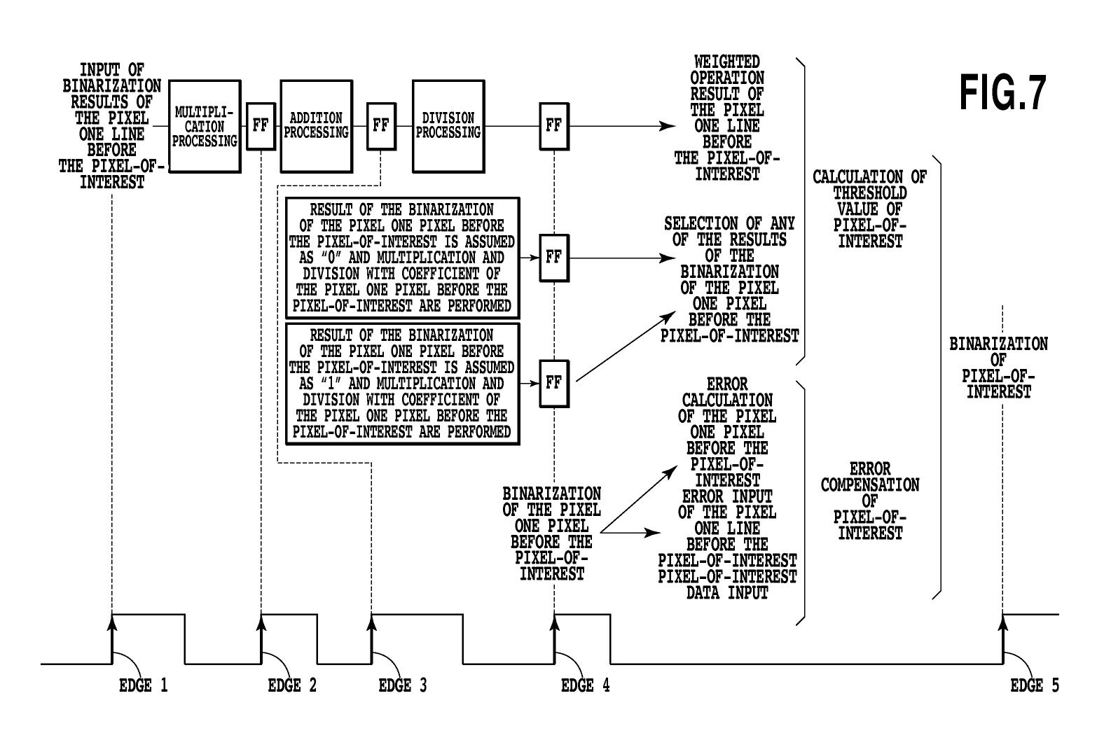

Next, with reference to FIG. 7, the following section will describe an order of the respective processings to clock edges in this embodiment.

When the pixel-of-interest is binarized at the rising of the clock edge 5, the processing shown in FIG. 7 is performed.

The calculation of the threshold value SL_L(n,m) to the pixel-of-interest one line before the pixel-of-interest in the threshold value calculation unit 11 (601) of FIG. 6 is started from the edge 1 and the processing is completed at the edge 4.

Specifically, at the clock edge 1, the binarization result storage memory (602) outputs the binarization result data for the line before the pixel-of-interest.

Thereafter, the multiplication circuit 11 (607), the multiplication circuit 12 (608), and the multiplication circuit 13 (609) in FIG. 6 multiply the respective pixels with the coefficient. Then, the multiplication result thereof is, at the timing of the clock edge 2, flip-flopped by the respective flip-flops (hereinafter “FF”) of FF11 (610), FF42 (611), and FF13 (612).

The data flip-flopped by the FF11 (610), FF12 (611), and FF13 (612) is inputted to the addition circuit 11 (615) of FIG. 6 and Ssum_L is calculated.

The data for Ssum_L is flip-flopped by the FF14 (614) at the timing of the clock edge 3.

The data flip-flopped by the FF14 (614) is inputted to the division circuit 11 (615) of FIG. 6. Then, the threshold value SL_L(n,m) to the pixel-of-interest in a line before the pixel-of-interest is calculated.

The data for SL_L(n,m) is flip-flopped by the FF15 (616) at the timing of the clock edge 4 and is outputted from the threshold value calculation unit 11 (601).

The processing of the threshold value SL_{—}1(n,m) corresponding to the pixel-of-interest the pixel one pixel before the pixel-of-interest and the threshold value SL_{—}0(n,m) corresponding to the pixel-of-interest the pixel one pixel before the pixel-of-interest in the threshold value calculation unit 12 (617) of FIG. 6 is completed at the edge 4.

Specifically, at the timing of the clock edge 3, various data required for the threshold value calculation unit (617) is inputted. Then, the multiplication circuit 14 (621) and the division circuit 12 (623), the multiplication circuit 15 (622), and the division circuit 13 (624) carry out the operation processing to calculate the values of SL_{—}1(h,m) and SL_{—}0(n,m).

The values of SL_{—}1(n,m) and SL_{—}0(n,m) are flip-flopped by the FF16 (625) and the FF17 (626) at the timing of the clock edge 4, respectively and the result is outputted from the threshold value calculation unit 12 (617).

The threshold value SL_L(n,m) corresponding to the pixel-of-interest in the line before the pixel-of-interest and the threshold value SL_{—}1(n,m) corresponding to the pixel-of-interest the pixel one pixel before the pixel-of-interest, and SL_{—}0(n,m) outputted at the timing of clock edge 4 are inputted to the threshold value calculation unit 13 (627).

The processings described hereinafter are carried out within one cycle from the clock edge 4 to the edge 5.

Any of the threshold value SL_{—}1(n,m) corresponding to the pixel-of-interest the pixel one pixel before the pixel-of-interest and SL_{—}0(n,m) inputted to the threshold value calculation unit 13 (627) of FIG. 6 selected, based on the processing result of the binarization of the pixel one pixel before the pixel-of-interest outputted at the timing of the edge 4.

The above selected data is added to the threshold value SL_L(n,m) to the pixel-of-interest in the line before the pixel-of-interest inputted to the threshold value calculation unit 13 (627) by the addition circuit 12 (629) of FIG. 6. Then, the threshold value SL(n,m) of the pixel-of-interest is outputted from the threshold value operation unit 13 (627).

At the same time, the binarization processing unit 1 (630) of FIG. 6 subjects Din(n,m) to the error compensation to the pixel-of-interest based on Er(n−1,m) and Ed(n,m−1).

Then, the threshold value SL(n,m) to the pixel-of-interest calculated by the above processing is compared with the error compensation data D(n,m) of the pixel-of-interest. Then, at the rising of the clock edge 5, the pixel-of-interest is binarized and the result is outputted from the binarization processing unit 1 (630).

As described above, the weighted operation of the pixel-of-interest in the line before the pixel-of-interest is processed in the multi-cycle manner at the timing at which the pixel one pixel before the pixel-of-interest is processed.

Specifically, the weighted operation of the pixel-of-interest in the line before the pixel-of-interest is started sooner so that the weighted operation is performed over a plurality of cycles to thereby reduce the load of the operation for the processing of the pixel-of-interest.

The multiplication and the division of the pixel one pixel before the pixel-of-interest with the coefficient are computed in advance at the timing of the processing of the pixel two pixels before the pixel-of-interest while assuming a case where the pixel one pixel before the pixel-of-interest has a processing result of “1” and a case where the pixel one pixel before the pixel-of-interest has a processing result of “0”. Then, when the result of the binarization of the pixel one pixel before the pixel-of-interest is obtained, the above operation result is selected and is used for the subsequent processing.

Specifically, for the multiplication and division of the pixel one pixel before the pixel-of-interest with the coefficient, the operation assuming both of the processing results of the binarization of the pixel one pixel before the pixel-of-interest is completed in advance to thereby reduce the load of the operation for the processing of the pixel-of-interest.

This can consequently realize the processing by the hardware based on the average density storage method with a higher speed.

### Second Embodiment

In the second embodiment, in order to configure the average density storage method by hardware, the binarization result of the pixel two or more pixels before the pixel-of-interest line is used to calculate the threshold value.

In the description of the second embodiment, a conventional technique also will be described in which the binarization result of the pixel two or more pixels before the pixel-of-interest line is used to calculate the threshold value.

First, the following section will describe in detail the conventional technique in which the binarization result of the pixel two or more pixels before the pixel-of-interest line is used to calculate the threshold value.

The conventional technique will be described with regard to the average density storage method based on the three processings such as the threshold value calculation, the binarization processing, and the error distribution.

### <Threshold Value Calculation in Conventional Technique>

When assuming that the pixel-of-interest to be subjected to the binarization processing is (n,m), those pixels in the line m before n−1 are already subjected to the binarization processing and thus the binary image data (“1” or “0”) exists.

The lines before the line m−1 are also already subjected to the binarization processing and thus the binary image data exists.

In the threshold value calculation processing, the binarization result of the pixels before the pixel-of-interest for which the binarization processing is completed is subjected to the weighted operation to thereby calculate the threshold value of the pixel-of-interest.

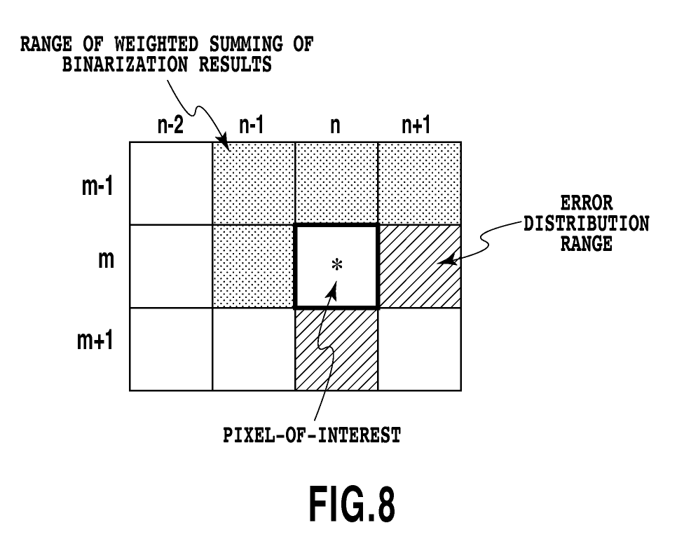

The following section will describe in detail, with reference to FIG. 8, the threshold value calculation in the conventional technique.

Here, as shown in FIG. 8, the range of pixels subjected to the threshold value calculation is 5 pixels of (n−1,m−1), (n,m−1), (n+1,m−1), (n−2, m), and (n−1,m).

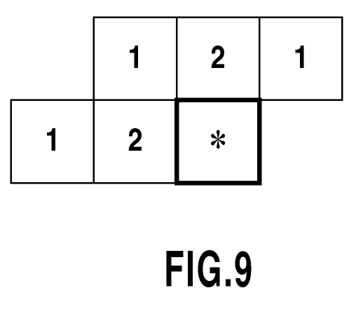

As shown in FIG. 9, the weighting coefficient to the respective pixels are set so that “1” to (n−1,m−1), “2” to (n,m−1), “1” to (n+1,m−1), and “1” to (n−2, m), and “2” to (n−1,m).

Next, the binarization processing results of the pixels before the pixel-of-interest are subjected to weighted operation processing so that a value of a part for outputting a color is “the Max value of the image data” (“255” in this embodiment) and a value of a part for not outputting a color is “0”.

Then, the threshold value SL(n,m) to the pixel-of-interest (n,m) is calculated by performing the weighted operation processing as shown below.

First, the respective pixels is multiplied with the coefficient in the manner as shown below.

S(n−1,m−1)=the weighting coefficient of (n−1,m−1)×the binarization processing result value of (n−1,m−1)×the Max value of the image data

S(n,m−1)=the weighting coefficient of (n,m−1)×the binarization processing result value of (n,m−1)×the Max value of the image data

S(n+1,m−1)=the weighting coefficient of (n+1,m−1)×the binarization processing result value of (n+1,m−1)×the Max value of the image data

S(n−2, m)=the weighting coefficient of (n−2, m)×the binarization processing result value of (n−2, m)×the Max value of the image data

S(n−1,m)=the weighting coefficient of (n−1,m)×the binarization processing result value of (n−1,m)×the Max value of the image data

Next, the sum of the multiplication results of the respective pixels is calculated.

Ssum(n,m)S(n−1,m−1)+S(n,m−1)+S(n+1,m−1)+S(n−2,m)+S(n−1,m)

Next, the above sum of the multiplication result is compensated.

SL(n,m)=Ssum(n,m)/{the weighting coefficient of (n−1,m−1)+the weighting coefficient of (n,m−1)+the weighting coefficient of (n+1,m−1)+the weighting coefficient of (n−2, m)+the weighting coefficient of (n−1,m)}

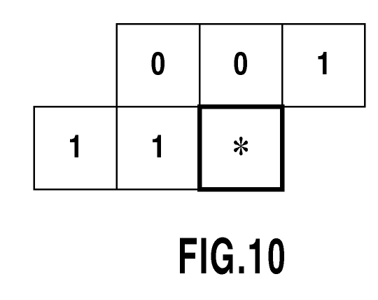

Thus, when the pixels before the pixel-of-interest have a binarization processing result is as shown in FIG. 10 for example, the threshold value SL(n,m) to the pixel-of-interest (n,m) is subjected to the weighted operation processing as shown below.

SL(n,m)={(1×0×255)+(2×0×255)+(1×1×255)+(1×1×255)+(2×1×255)}/(1+2+1+1+2)=146

### <Binarization Processing in Conventional Technique>

The pixel-of-interest image data is subjected to the error compensation based on the binarization error of the precedent pixel. Then, the result is compared with the threshold value and the binarization processing is performed.

In this processing, as in the embodiment 1, as shown in FIG. 8, an error is distributed to a pixel following the pixel-of-interest in the pixel-of-interest line and a pixel that is in a line one line lower than the pixel-of-interest line and that is at the same position as that of the pixel-of-interest. Thus, the error data from a pixel in the pixel-of-interest line the pixel one pixel before the pixel-of-interest and the error data from a pixel that is in the line one line before the pixel-of-interest and that is at the same position as that of the pixel-of-interest are added to the input data of the pixel-of-interest.

Here, the input data of the pixel-of-interest (n,m) is assumed as Din(n,m). The binarization processing error data of the pixel in the pixel-of-interest line the pixel one pixel before the pixel-of-interest is assumed as Er(n−1,m). The binarization processing error data of the pixel that is in the line one line before the pixel-of-interest and that is at the same position as that of the pixel-of-interest is assumed as Ed(n,m−1). Then, D(n,m), which is the image data of the pixel-of-interest after the error compensation, is calculated by the operation as shown below.

D(n,m)=Din(n,m)+Er(n−1,m)+Ed(n,m−1)

For example, in the case of Din(n,m)=120, Er(n−1,m)=14, and Ed(n,m−1), the data D(n,m) after the error compensation is a value as shown below.

D(n,m)=120+14+(−8)=126

The error data Er and Ed will be described later.

Next, D(n,m) is compared with SL(n,m) that is the previously-calculated threshold value corresponding to the pixel-of-interest to judge whether a color is outputted or not to the pixel-of-interest in the manner as shown below to thereby determine the binarization result output Bin(n,m).

In the case of D(n,m)≧SL(n,m) for example, it is judged that a color is outputted to the pixel-of-interest to determine Bin(n,m)=1. In the case of D(n,m)<SL(n,m) on the other hand, no color is outputted to determine Bin(n,m)=0.

In the above-described example for example, D(n,m)=126 and SL(n,m)=146 lead to “D(n,m)<SL(n,m)”. Thus, it is judged that no color is outputted to the pixel-of-interest, thus determining Bin(n,m)=0.

### <Error Distribution in Conventional Technique>

Next, the difference between the threshold value SL(n,m) and the image data D(n,m) after the error compensation is assumed as the binarization error E(n,m) and is distributed to the subsequent processing pixels.

E(n,m)=SL(n,m)−D(n,m)

In the error distribution processing, as shown in FIG. 8, the error data is distributed to the pixel in the pixel-of-interest line at a position moved to the right side of the pixel-of-interest by one pixel and the pixel that is at a position one line lower than the pixel-of-interest and that is at the same position as that of the pixel-of-interest.

Here, the error data distributed to the pixel in the pixel-of-interest line at a position moved to the right side is assumed as Er(n,m) and the error data distributed to the two pixels of the pixel that is at a position one line lower than the pixel-of-interest and that is at the same position as that of the pixel-of-interest is assumed as Ed(n,m). Then, ½ of E(n,m) is distributed to the pixel in the pixel-of-interest line at a position moved to the right side of the pixel-of-interest by one pixel and the pixel that is at a position one line lower than the pixel-of-interest and that is at the same position as that of the pixel-of-interest, respectively.

In this case, Er(n,m)=E(n,m)/2 and Ed(n,m)=E(n,m)/2 are established.

For example, in the above-described example, E(n,m)=SL(n,m)−D(n,m)=146−126=20 is calculated. Then, Er(n,m)=E(n,m)/2=20/2=10 and Ed(n,m)=E(n,m)/2=20/2=10 are obtained.

The above Er(n,m) is used for the error compensation of Din(n+1,m) and Ed(n,m) is used for the error compensation of Din(n,m+1).

### <Hardware of Conventional Technique>

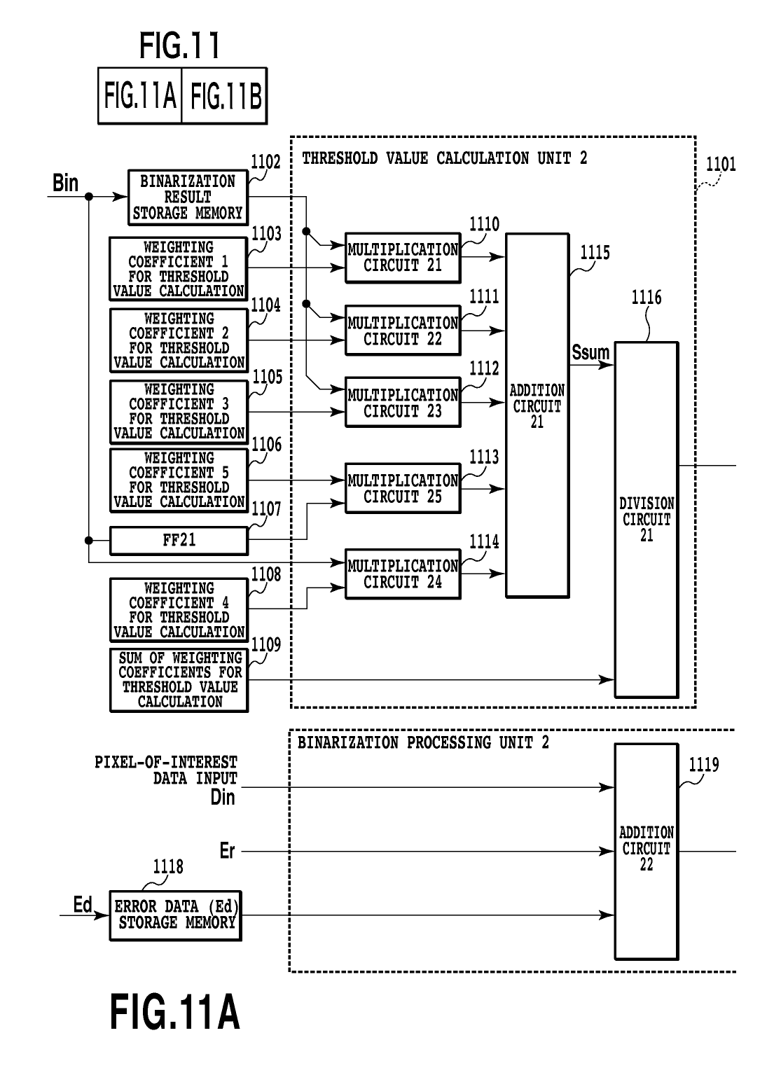

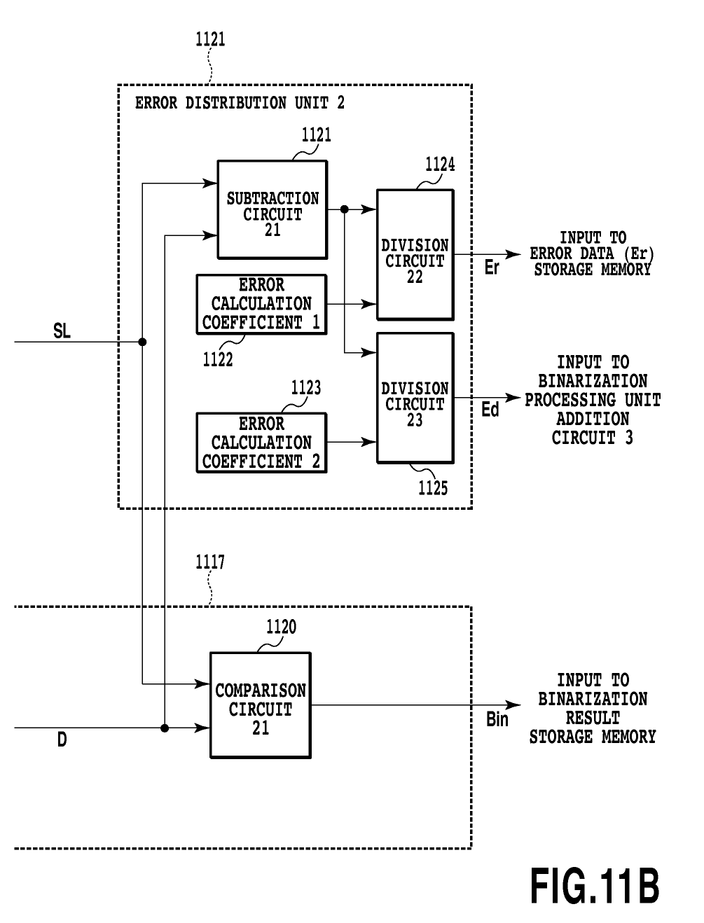

The hardware for realizing the average density storage method in the conventional example 2 is as shown in FIG. 11.

### <Threshold Value Calculation Unit 2 (1101)>

Regarding the pixels in the line m−1 around the pixel-of-interest (n,m), the binarization processing is already completed and the binarized image data exists.

These pieces of binarized image data are stored in a binarization result storage memory 1102.

The threshold value calculation unit 2 (1101) performs the weighted operation to the image data already subjected to the binarization processing stored in the binarization result storage memory 1102 to calculate the threshold value of the pixel-of-interest.

The Weighting coefficient 1 for threshold value calculation (1103) stores therein, by a memory for example, the weighting coefficient of (n−1,m−1).

The Weighting coefficient 2 for threshold value calculation (1104) stores therein, by a memory for example, the weighting coefficient of (n,m−1).

The Weighting coefficient 3 for threshold value calculation (1105) stores therein, by a memory for example, the weighting coefficient of (n+1,m−1).

The Weighting coefficient 4 for threshold value calculation (1108) stores therein, by a memory for example, the weighting coefficient of (n−1,m).

The Weighting coefficient 5 for threshold value calculation (1106) stores therein, by a memory for example, the weighting coefficient of (n−2, m).

The weighting coefficient for threshold value calculation (1109) stores therein, by a memory for example, the sum of weighting coefficients to the pixels of (n−1,m−1), (n,m−1), (n+1,m−1), (n−2, m), and (n−1,m).

The threshold value calculation unit 2 (1101) of FIG. 11 causes the binarization result storage memory 1102 to output the binarized image data for the three pixels of (n−1,m−1), (n,m−1), and (n+1,m−1).

Then, the multiplication circuit 21 (1110) multiplies the binarized image data of the pixel (n−1,m—1) with the weighting coefficient of (n−1,m−1) and the Max value of the image data.

The multiplication circuit 22 (1111) multiplies the binarized image data of the pixel (n,m−1) with the weighting coefficient of (n,m−1) and the Max value of the image data.

The multiplication circuit 23 (1112) multiplies the binarized image data of the pixel (n+1,m−1) with the weighting coefficient of (n+1,m−1) and the Max value of the image data.

The threshold value calculation unit 2 (1101) inputs, as the binarized image data of the pixel (n−1,m), the binarization result Bin(n,m) outputted through the previous binarization processing directly to the multiplication circuit (1114). Then, the multiplication circuit 24 (1114) multiplies the weighting coefficient of the pixel (n−1,m) stored in the Weighting coefficient 4 for threshold value calculation (1108) with the Max value of the image data.

The threshold value calculation unit 2 (1101) inputs, as the binarized image data of the pixel (n−2, m), the data obtained by flip-flopping the binarization result Bin(n,m) outputted through the previous binarization processing by FF21 (1107) for one clock to the multiplication circuit 25 (1113). Then, the multiplication circuit 25 (1113) multiplies the weighting coefficient of the pixel of (n−2, m) stored in the Weighting coefficient 5 for threshold value calculation (1106) with the Max value of the image data.

Then, the threshold value calculation unit 2 (1101) inputs the output values from the multiplication circuit 21 (1110), the multiplication circuit 22 (1111), the multiplication circuit 23 (1112), the multiplication circuit (1114), and the multiplication circuit 25 (1113) to the addition circuit 21 (1115). Then, the threshold value calculation unit 2 (1101) calculates Ssum(n,m) based on this operation.

Then, the threshold value calculation unit 2 (1101) causes the division circuit 21 (1116) to divide Ssum(n,m) outputted from the addition circuit 21 (1115) by the value of the sum of the weighting coefficients stored in the weighting coefficient sum (1109) for the threshold value calculation. Then, the threshold value calculation unit 2 (1101) calculates, based on this operation, SL(n,m) as the threshold value to the pixel-of-interest.

### <Binarization Processing Unit 2 (1117)>

The binarization processing unit 2 (1117) compares, with regard to the pixel-of-interest image data, D(n,m) subjected to the error compensation based on the binarization error of the precedent pixels with the threshold value SL(n,m) calculated by the threshold value calculation unit 2 (1101) to perform a binarization processing.

The addition circuit 22 (1119) of the binarization processing unit 2 (1117) of FIG. 11 receives Din(n,m) and the error data Er(n−1,m) that is outputted from the error distribution unit 2 (1121) (which will be described later) and that is calculated by the binarization processing of the pixel one pixel before the pixel-of-interest.

The error data (Ed)storage memory (1118) stores, among the binarization error of the pixels before the pixel-of-interest, the binarization processing error data Ed(n,m−1) of the pixel that is in the line one line before the pixel-of-interest and that is at the same position as that of the pixel-of-interest.

The error data Er and Ed will be described later.

As shown in FIG. 11, the binarization processing unit 2 (1117) receives the following three data. Specifically, Din(n,m), the binarization processing error data Er(n−1,m) for the pixel in the pixel-of-interest line the pixel one pixel before the pixel-of-interest, and the binarization processing error data Ed(n,m−1) for the pixel that is in the line one line before the pixel-of-interest and that is the same position as that of the pixel-of-interest are inputted to the binarization processing unit 2 (1117). Here, Din(n,m) is pixel-of-interest input data.

The addition circuit 22 (1119) of the binarization processing unit 2 (1117) adds the three data of Din(n,m), Er(n−1,m), and Ed(n,m−1) to calculate the data D(n,m) after the error compensation of the pixel-of-interest.

Next, the comparison circuit 21 (1120) of binarization processing unit 2 (1117) compares the data D(n,m) after the error compensation of the pixel-of-interest with the threshold value SL(n,m) to the pixel-of-interest calculated by the threshold value calculation unit 2 (1101). Then, the comparison circuit 21 (1120) of the binarization processing unit 2 (1117) judges whether a color is outputted to the pixel-of-interest (Bin(n,m)=1) or no color is outputted thereto (Bin(n,m)=0) to output the binarization result.

The comparison circuit 21 (1120) judges Bin(n,m)=1 or Bin(n,m)=2 in the manner as shown below. Specifically, in the case of D(n,m)≧SL(n,m), the comparison circuit 21 (1120) judges to output a color to judge Bin(n,m)=1. In the case of D(n,m)<SL(n,m) on the other hand, the comparison circuit 21 (1120) judges not to output a color to judge Bin(n,m)=0.

Bin(n,m), which is the binarization result of the pixel-of-interest outputted from the comparison circuit 21 (1120), is inputted to the binarization result storage memory 1102, the multiplication circuit 24 (1114) of the threshold value calculation unit 2 (1101), or the FF21 (1107), respectively.

The data stored in the binarization result storage memory 1102 is used for the threshold value calculation for the binarization processing of the line following the line already subjected to the binarization processing.

The data inputted to the threshold value calculation unit 2 (1101) of the multiplication circuit 24 (1114) is used for the threshold value calculation for the binarization processing of the next pixel.

The data inputted to the FF21 (1107) is flip-flopped by the FF21 (1107) by one lock and the result is used for the threshold value calculation for the binarization processing for the case where the pixel 2 pixels below the pixel-of-interest is the pixel-of-interest.

### <Error Distribution Unit 2 (1121)>

The error distribution unit 2 (1121) assumes a difference between the threshold value SL(n,m) of the pixel-of-interest calculated by the threshold value calculation unit 2 (1101) and the data (n,m) after the error compensation of the pixel-of-interest as the binarization error E(n,m) to distribute the binarization error E(n,m) to the to-be-processed pixel.

First, the subtraction circuit 21 (1121) of the error distribution unit 2 (1121) calculates E(n,m) that is a difference between the threshold value SL(n,m) of the pixel-of-interest calculated by the threshold value calculation unit 2 (1101) and the data D(n,m) after the error compensation of the pixel-of-interest.

In the processing performed by the error distribution unit 2 (1121), as shown in FIG. 8, the error data is distributed to the pixel in the pixel-of-interest line at a position moved to the right side of the pixel-of-interest by one pixel and the pixel that is at a position one line lower than the pixel-of-interest and that is at the same position as that of the pixel-of-interest.

Here, the error data distributed to the pixel in the line of the pixel-of-interest (n,m) at a position moved to the right side of the pixel-of-interest by one pixel is assumed as Er(n,m) and the error data distributed to the pixel that is at a position one line lower than the pixel-of-interest (n,m) and that is at the same position as that of the pixel-of-interest is Ed(n,m). Then, the error data is distributed to the respective pixels at the right side and at the lower side of the pixel-of-interest (n,m).

Then, ½ of the error data is distributed to the two parts of the pixel in the pixel-of-interest line at a position moved to the right side of the pixel-of-interest by one pixel and the pixel that is at a position one line lower than the pixel-of-interest and that is at the same position as that of the pixel-of-interest.

The error data distributed to the pixel in the line of the pixel-of-interest (n,m) at a position moved to the right side of the pixel-of-interest by one pixel is calculated by the division circuit 22 (1124).

The error data Ed(n,m) distributed to the pixel that is at a position one line lower than the pixel-of-interest (n,m) and that is at the same position as that of the pixel-of-interest is calculated by the division circuit 23 (1125).

Here, the error calculation coefficient 1 (1122) stores therein the coefficients for calculating the binarization errors from E(n,m) to Er(n,m). The coefficients for calculating the binarization errors from E(n,m) to Er(n,m) are read out from the error calculation coefficient 1 (1122) and are inputted to the division circuit 22 (1124).

The error calculation coefficient 2 (1123) also stores therein the coefficients for calculating the binarization errors from E(n,m) to Ed(n,m). The coefficients for calculating the binarization errors from E(n,m) to Ed(n,m) are read out from the error calculation coefficient 2 (1123) and are inputted to the division circuit 23 (1125).

The error data Ed(n,m) distributed to the pixel that is at a position one line lower than the pixel-of-interest (n,m) and that is at the same position as that of the pixel-of-interest is stored in the error data (Ed) storage memory (1118).

The error data Er(n,m) distributed to the pixel in the line of the pixel-of-interest (n,m) at a position moved to the right side of the pixel-of-interest by one pixel is inputted to the addition circuit 22 (1119) of the binarization processing unit 2 (1117).

The error data (Ed(n,m)) stored in the error data (Ed) storage memory (1118) is used for the error compensation by the binarization processing unit 2 (1117) for the binarization processing of the line following the line of the pixel-of-interest (n,m).

The error data (Er(n,m)) inputted to the addition circuit 22 (1119) of the binarization processing unit is used for the error compensation by the binarization processing unit 2 (1117) for the binarization processing of the pixel following the pixel-of-interest (n,m).

### <Disadvantage of Conventional Technique>

In the above conventional technique, in order to output the processing result of the average density storage method of one pixel per one clock, it is required to complete all of threshold value calculation processing, binarization processing, and error distribution processing within one clock.

Specifically, it is required to complete all processings of the threshold value calculation unit 2 (1101), the binarization processing unit 2 (1117), and the error distribution unit 2 (1121) of FIG. 11 within one clock.

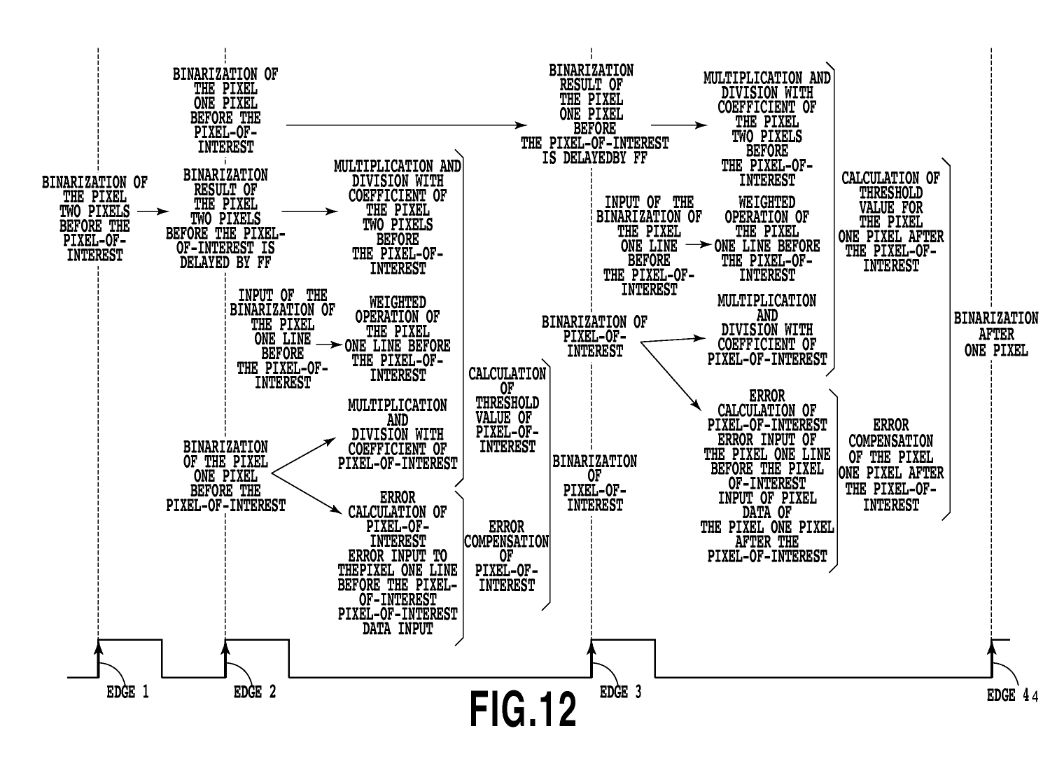

Next, with reference to FIG. 12, the following g section will describe an order of the respective processings performed to a clock edge in the conventional technique.

When the pixel-of-interest is binarized at the rising of the clock edge 3, the processing as shown in FIG. 12 is performed.

At the same timing as that at which the binarization of the pixel one pixel before the pixel-of-interest is completed at the rising of the clock edge 3 and the binary data is outputted, the binarization of the pixel one line before the pixel-of-interest used for the calculation of the threshold value of the pixel-of-interest that is inputted from the binarization result storage memory 1102 is inputted.

Next, based on the binarization of the pixel one line before the pixel-of-interest, the weighted operation regarding the area one line before the pixel-of-interest is performed.

The binarization result for the pixel 2 pixels before the pixel-of-interest is subjected by the FF21 (1107) to a one clock delay processing at the clock edge 2 to perform the operations of the multiplication and division of the pixel two pixels before the pixel-of-interest with the weighting coefficient.

At the same time, based on the binarization result of the pixel one pixel before the pixel-of-interest, the operations of the multiplication and division of the pixel one pixel before the pixel-of-interest with the weighting coefficient are performed. Then, based on the multiplication and division results, the operation result for the pixel two pixels before the pixel-of-interest, and the weighted operation result for the area one line before the pixel-of-interest, the threshold value to the pixel-of-interest is calculated.

In parallel with the above processing, Din(n,m) is subjected to the error compensation to the pixel-of-interest based on the binarization processing error data (Er(n−1,m)) and the binarization processing error data (Ed(n,m−1)) inputted from the error data (Ed) storage memory (1118).

Then, the threshold value SL(n,m) to the pixel-of-interest calculated by the above processing is compared with the error compensation data D(n,m) of the pixel-of-interest to perform the binarization of the pixel-of-interest at the rising of the clock edge 3 and the result is outputted from the binarization processing unit 2 (1117).

Thereafter, at the next edge 4, the pixel one pixel after the pixel-of-interest is assumed as the pixel-of-interest and is subjected to the repetition of the same processing.

In the current situation, the multiplication for the threshold value calculation processing, addition, division, and the subtraction and division for the error distribution processing for example must be performed sequentially.

Furthermore, for an improved image quality, an increased gray level number of image data causes an increased bit number of image data, an increased area subjected to the weighted operation processing for the threshold value calculation, and an expanded area subjected to the error distribution for example, thus increasing the operation load than ever.

Thus, when an operation at an early frequency is tried to be performed, various operation processings are not completed within one clock, thus causing a disadvantage of where a high-speed operation is prevented.

The following section will describe in detail the second embodiment.

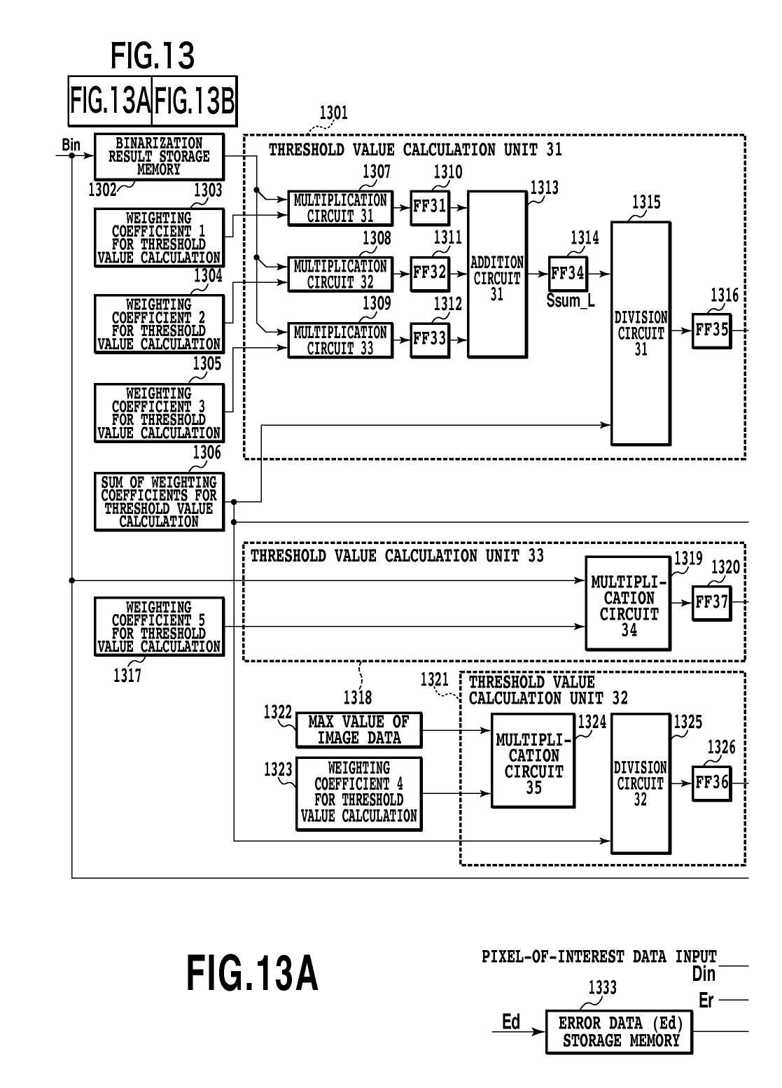

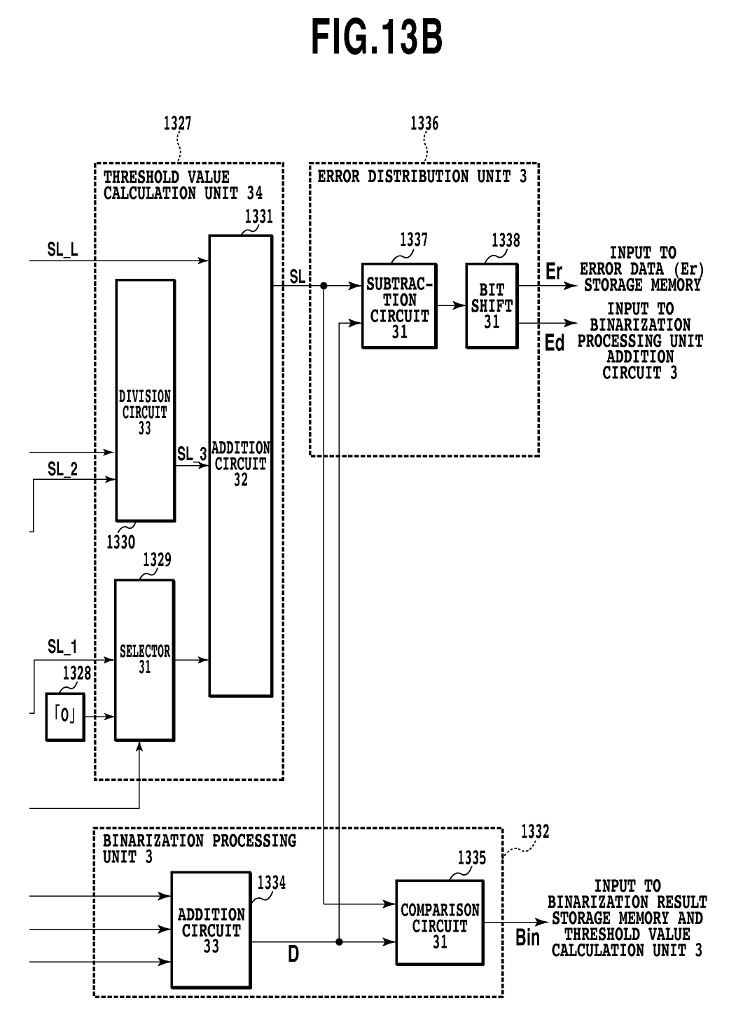

First, with reference to FIG. 13, the hardware in the second embodiment will be described in detail.

### <Threshold Value Calculation Unit 31 (1301)>

Regarding the pixels in the line m−1 around the pixel-of-interest (n,m), the binarization processing is already completed and the binarized image data exists.

These pieces of binarized image data are stored in the binarization result storage memory 1302.

The threshold value calculation processing unit 31 (1301) subjects, to the weighted operation, the pixel data already subjected to the binarization processing that is stored in the binarization result storage memory 1302. In particular, the threshold value calculation processing unit 31 (1301) subjects the line before the pixel-of-interest to the weighted operation.

The Weighting coefficient 1 for threshold value calculation (1303) stores therein, by a memory for example, the weighting coefficient of (n−1,m−1).

The Weighting coefficient 2 for threshold value calculation (1304) stores therein, by a memory for example, the weighting coefficient of (n,m−1).

The Weighting coefficient 3 for threshold value calculation (1305) stores therein, by a memory for example, the weighting coefficient of (n+1,m−1).

The sum (1306) of the weighting coefficients for the threshold value calculation stores therein, by a memory for example, the sum of the weighting coefficients to the pixels (n−1,m−1), (n,m−1) (n+1,m−1), (n−2, m), and (n−1,m).

The threshold value calculation unit 31 (1301) of FIG. 13 causes the binarization result storage memory 1302 to output the binarized image data of the three pixels of (n−1,m−1), (n,m−1), and (n+1,m−1).

Then, multiplication circuit 31 (1307) causes the binarization result storage memory (1302) to receive the binarized data for the pixel (n−1,m−1). Then, the multiplication circuit 31 (1307) multiplies the binarized data, the weighting coefficient of (n−1,m−1), and the Max value of the image data to output the result. Here, the Max value of the image data is “255” for example.

Furthermore, the multiplication circuit 32 (1308) receives, from the binarization result storage memory (1302), the binarized data for the pixel (n,m−1) to multiply the binarized data, the weighting coefficient of (n,m−1), and the Max value of the image data to thereby output the result. Here, the Max value of the image data is “255” for example.

Furthermore, the multiplication circuit 33 (1309) receives the binarized data for the pixel (n+1,m−1) from the binarization result storage memory (1302) to multiply the binarized data, the weighting coefficient of (n+1,m−1), and the Max value of the image data to thereby output the result. Here, the Max value of the image data is “255” for example.

Next, the addition circuit 31 (1313) receives the output value of multiplication circuit 31 (1307) via the FF31 (1310).

Furthermore, the addition circuit 31 (1313) receives the output value of multiplication circuit 32 (1308) via the FF32 (1311).

Furthermore, the addition circuit 31 (1313) receives the output value of the multiplication circuit 33 (1309) via the FF33 (1312).

Then, the addition circuit 31 (1313) adds the output value of the multiplication circuit 31 (1307), the output value of the multiplication circuit 32 (1308), and the output value of the multiplication circuit 33 (1309) to calculate the sum (Ssum_L) of the multiplication results of the respective pixels in the line before the pixel-of-interest with the coefficient to output the result.

Next, the division circuit 31 (1315) receives the output value (Ssum_L) of the addition circuit 31 (1313) via the FF34 (1314) and receives the value stored in the sum (1306) of the weighting coefficients for the threshold value calculation. Then, the division circuit 31 (1315) divides the sum Ssum_L outputted from the addition circuit 31 (1313) of the multiplication results of the respective pixels in the line before the pixel-of-interest with the coefficient by the value stored in the sum (1306) of the weighting coefficients for the threshold value calculation to calculate SL_L(n,m) to output the result. Here, SL_L(n,m) is the threshold value to the pixel-of-interest one line before the pixel-of-interest. The operation as described above is a weighted operation performed by the threshold value calculation unit 31 (1301).

### <Threshold Value Calculation Unit 32 (1321)>

The threshold value calculation unit 32 (1321) performs the multiplication and division of the binarization result of the pixels before the pixel-of-interest for which the binarization processing is completed with the coefficient. In particular, the threshold value calculation unit 32 (1321) performs the operation of the binarization result of the pixel one pixel before the pixel-of-interest.

The threshold value calculation unit 32 (1321) assumes, prior to the completion of the binarization processing of the pixel one pixel before the pixel-of-interest, a case where the pixel one pixel before the pixel-of-interest has a binarization processing result of “1” and performs in advance the multiplication and division of the pixel one pixel before the pixel-of-interest with a coefficient.

In this embodiment, when the pixel one pixel before the pixel-of-interest has a binarization processing result of “1”, the multiplication and division results of the pixel one pixel before the pixel-of-interest with the coefficient is assumed as SL_{—}1 (n,m).

In this embodiment, when the pixel one pixel before the pixel-of-interest has a binarization processing result of “0”, then the value added by the threshold value calculation unit 34 (1327) is “0”. Thus, no particular operation circuit is used and the threshold value calculation unit 34 (1327) inputs the value of “0” to the selector 31 (1329).

Thereafter, the threshold value calculation unit 34 (1327) calculates the threshold value SL(n,m) to the pixel-of-interest.

The following section will describe in detail, with reference to FIG. 13, the threshold value calculation unit 32 (1321).

The Weighting coefficient 4 for threshold value calculation (1323) stores therein the weighting coefficient of (n−1,m).

The sum (1306) of the weighting coefficients for the threshold value calculation stores therein the sum of the weighting coefficients of (n−1,m−1), (n,m−1), (n+1,m−1), (n−2, m), and (n−1,m).

The multiplication circuit 35 (1324) multiplies the Max value of the image data 1322 with the weighting coefficient of (n−1,m) stored in the Weighting coefficient 4 for threshold value calculation (1323).

Thereafter, the division circuit 32 (1325) divides the multiplication result outputted from the multiplication circuit 35 (1324) of multiplying the pixel one pixel before the pixel-of-interest with the coefficient by the value stored in the sum (1306) of the weighting coefficients for the threshold value calculation. Then, the division circuit 32 (1325) calculates, based on this operation, the threshold value SL_{—}1 (n,m) to the pixel-of-interest one pixel before the pixel-of-interest.

### <Threshold Value Calculation Unit 33 (1318)>

The threshold value calculation unit 33 (1318) multiplies the binarization result of the pixels before the pixel-of-interest for which the binarization processing is completed with the coefficient. In particular, the threshold value calculation unit 33 (1318) multiplies the binarization result of the pixels before the pixel-of-interest for which the binarization processing is completed with the coefficient for the pixel two pixels before the pixel-of-interest.

When the multiplication with the coefficient for the pixel two pixels before the pixel-of-interest is performed, in the conventional technique, as shown in FIG. 11, the binary output data Bin(n,m) outputted from the binarization processing for the pixel two pixels before the pixel-of-interest is flip-flopped one time by the FF21 (1107), thereby delaying the data by one clock. Thereafter, the multiplication circuit 25 (1113), the addition circuit 21 (1115), and the division circuit (1116) perform a operation processing to calculate the threshold value SL(n,m) of the pixel-of-interest.

However, in this embodiment, the binarization result Bin (n,m) outputted from the binarization processing for the pixel two pixels before the pixel-of-interest is directly inputted to the threshold value calculation unit 33 (1318) and the operation processing by the multiplication circuit 34 (1319) is performed. Thereafter, the output from the multiplication circuit 34 (1319) is flip-flopped one time by the FF37 (1320).

Then, the subsequent division processing is performed by the division circuit 33 (1330) of the threshold value calculation unit 34 (1327). Furthermore, the addition with the threshold value calculated from the binarization of the pixel in the line before the pixel-of-interest and the pixel one pixel before the pixel-of-interest is performed by the addition circuit 32 (1331).

Specifically, in this embodiment, regarding the coefficient with the threshold value for the binarization processing result of the pixel two pixels before the pixel-of-interest, all processings of multiplication, addition, and division included in the operation are not performed within one cycle.

Specifically, in this embodiment, the multiplication and division results to the binarization processing result for the pixel two pixels before the pixel-of-interest are completed by the time at which the pixel-of-interest binarization processing is performed so that the value can be used. Thus, in this embodiment, the operation with the coefficient for the binarization processing result for the pixel two pixels before the pixel-of-interest is performed for two cycles.

As a result, in this embodiment, the operation processing performed within one cycle is dispersed, thus realizing an operation at a clock at a higher frequency.

The following section will describe in detail, with reference to FIG. 13, the threshold value calculation unit 33.

The Weighting coefficient 5 for threshold value calculation (1317) stores the weighting coefficient of (n−2, m).

The multiplication circuit 34 (1319) multiplies the binary data inputted from the binarization processing unit 3 (1332) with the weighting coefficient of (n−2, m) stored in the Weighting coefficient 5 for threshold value calculation (1317). Then, the multiplication circuit 34 (1319) assumes the value obtained from the multiplication as SL_{—}2(n,m) to output the value from the threshold value calculation unit 33 (1318) via the FF37 (1320).

### <Threshold Value Calculation Unit 34 (1327)>

The threshold value calculation unit 34 (1327) has a division circuit 33 (1330), a selector 31 (1329), and an addition circuit 32 (1331).

The division circuit 33 (1330) divides the output value SL-2 (n,m) from the threshold value calculation unit 33 (1318) by the sum of the weighting coefficients of the respective pixels stored in the sum (1306) of the weighting coefficients for the threshold value calculation. Then, the division circuit 33 (1330) outputs the division result SL_{—}3 (n,m).

The selector 31 (1329) selects any of SL_{—}1(n,m) and the threshold value of “0” to the pixel one pixel before the pixel-of-interest assuming a case where the binarization result of the pixel one pixel before the pixel-of-interest is “0” (1328) to input the value to the addition circuit 32 (1331).

The addition circuit 32 (1331) adds the previously-calculated SL_L(n,m), the threshold value (SL_{—}1 (n,m) outputted from selector 31 (1329) for the pixel one pixel before the pixel-of-interest, and SL_{—}3 (n,m). Then, the addition circuit 32 (1331) calculates the threshold value SL(n,m) to the pixel-of-interest obtained from the addition.

### <Binarization Processing Unit 3 (1332)>

The binarization processing unit 3 (1332) compares the data (D(n,m)) after the error compensation of the pixel-of-interest with the threshold value SL(n,m) calculated by the threshold value calculation unit 34 (1327) to perform a binarization processing.

Er(n−1,m) is error data that is outputted from the error distribution unit 3 (1336) (which will be described later) and that is calculated based on the binarization result of the pixel one pixel before the pixel-of-interest.

The error data (Ed) storage memory (1333) stores the error data regarding Ed(n,m−1) among the binarization error of the pixels before the pixel-of-interest.

The error data Er and Ed will be described later.

The binarization processing unit 3 (1332) receives the following three pieces of data as shown in FIG. 13.

Specifically, Din(n,m), Er(n−1,m), and Ed(n,m−1) are inputted to the binarization processing unit 3 (1332). Here, Din(n,m) is the pixel-of-interest input data. Er(n−1,m) is the binarization processing error data of the pixel in the pixel-of-interest line one pixel before the pixel-of-interest. Ed(n,m−1) is the binarization processing error data for the pixel that is in the line one line before the pixel-of-interest and that is at the same position as that of the pixel-of-interest.

The addition circuit 33 (1334) adds the above three pieces of data to calculate the data D(n,m) after the error compensation of the pixel-of-interest.

Next, the comparison circuit 31 (1335) of the binarization processing unit 3 (1332) compares the data D(n,m) after the error compensation of the pixel-of-interest with the threshold value SL(n,m) to the pixel-of-interest calculated by the threshold value calculation unit 34 (1327). Then, the comparison circuit 31 (1335) judges whether to output a color to the pixel-of-interest (Bin(n,m)=1) or not to output a color (Bin(n,m)=0) to output the binarization result.

The comparison circuit 31 (1335) judges Bin(n,m)=1 or Bin(n,m)=2 in the manner as shown below. Specifically, in the case of D(n,m)≧SL(n,m), the comparison circuit 31 (1335) judges to output a color to judge Bin(n,m)=1. In the case of D(n,m)<SL(n,m) on the other hand, the comparison circuit 31 (1335) judges not to output a color to judge Bin(n,m)=0.

Bin(n,m) outputted from the comparison circuit 31 (1335) is inputted to the binarization result storage memory (1302), the multiplication circuit 34 (1319) of the threshold value calculation unit 33 (1318), and the selector 31 (1329) of the threshold value calculation unit 34 (1327), respectively.

The data stored in the binarization result storage memory (1302) is used to calculate the threshold value for the binarization processing for the line following the line already subjected to the binarization processing.

The data inputted to the multiplication circuit 34 (1319) of the threshold value calculation unit 33 (1318) is used to calculate the threshold value for the binarization processing for the pixel two pixels after the pixel already subjected to the binarization processing.

The data inputted to the selector 31 (1329) of the threshold value calculation unit 34 (1327) is used to calculate the threshold value for the binarization processing of the pixel following the pixel already subjected to the binarization processing.

### <Error Distribution Unit 3 (1336)>

The error distribution unit 3 (1336) assumes the difference between the threshold value SL(n,m) of the pixel-of-interest calculated by the threshold value calculation unit 34 (1327) and the data D(n,m) after the error compensation of the pixel-of-interest as the binarization error E(n,m) to distribute the binarization error E(n,m) to the to-be-processed pixel.

First, the subtraction circuit 31 (1337) of the error distribution unit 3 (1336) calculates E(n,m) that is a difference between the threshold value SL(n,m) of the pixel-of-interest calculated by the threshold value calculation unit 34 (1327) and the data D(n,m) after the error compensation of the pixel-of-interest.

In the processing performed by the error distribution unit 3 (1336), as shown in FIG. 8, the error data is distributed to the pixel in the line of the pixel-of-interest at a position moved to the right side of the pixel-of-interest by one pixel and the pixel that is at a position one line lower than the pixel-of-interest and that is at the same position as that of the pixel-of-interest.

Here, Here, the error data distributed to the pixel in the line of the pixel-of-interest (n,m) at a position moved to the right side of the pixel-of-interest by one pixel is assumed as Er(n,m) and the error data distributed to the pixel that is at a position one line lower than the pixel-of-interest (n,m) and that is at the same position as that of the pixel-of-interest is assumed as Ed(n,m). Then, the error data is distributed to the respective pixels at the right side and at the lower side of the pixel-of-interest (n,m).

In this embodiment, for the purpose of reducing the operation processing, the value of E(n,m) as a difference between the threshold value SL(n,m) of the pixel-of-interest and the data D(n,m) after the error compensation of the pixel-of-interest is not subjected to the processing by the division circuit. Instead, the bit shift 31 (1338) is used to delete the least significant one bit of the data E(n,m) to thereby output the value equivalent to that obtained by dividing the data E(n,m) by 2 as Ed(n,m) and Er(n,m).

Then, Ed(n,m) is inputted to the error data (Ed) storage memory (1333).

Furthermore, Er(n,m) is inputted to the addition circuit 33 (1334) of the binarization processing unit 3 (1332).

The data inputted to the error data (Ed)storage memory (1333) is used for the error compensation by the binarization processing unit for the binarization processing of the line following the pixel-of-interest line.

The data inputted to the addition circuit 33 (1334) of the binarization processing unit 3 (1332) is used for the error compensation by the binarization processing unit 3 (1332) for the binarization processing of the pixel following the pixel-of-interest.

Next, the following section will describe in detail clocks and the processing timing in the second embodiment.

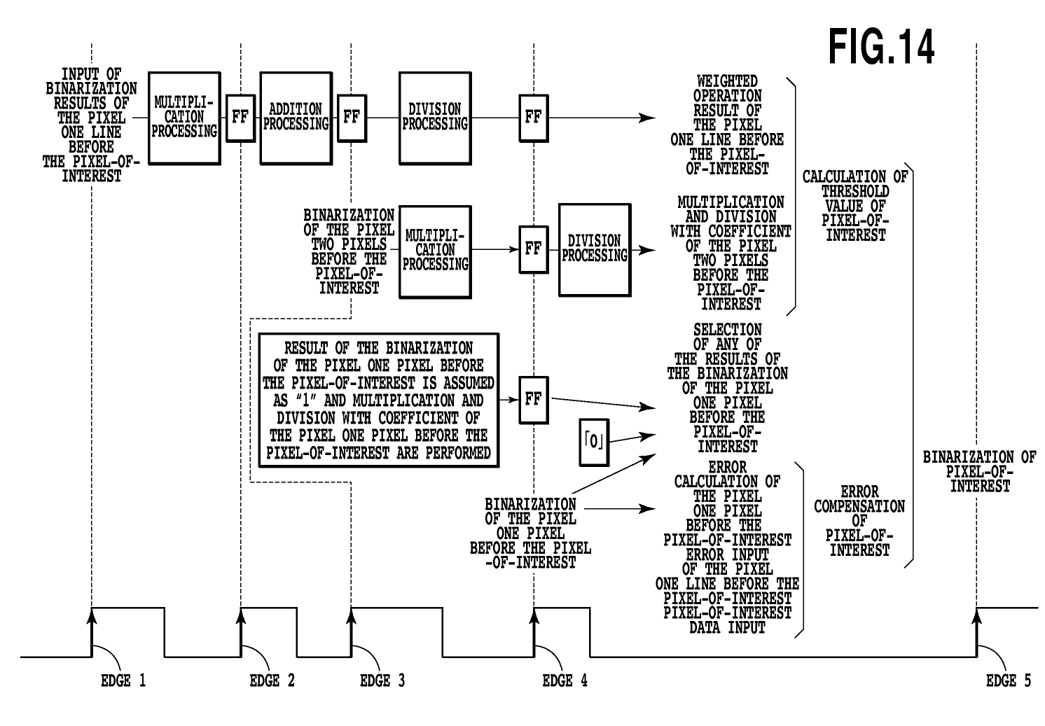

Specifically, with reference to FIG. 14, the following section will describe in detail an order of the respective processings to the clock edges in this embodiment.

When the pixel-of-interest is binarized at the rising of the clock edge 5, the processing shown in FIG. 14 is performed.

The calculation of the threshold value SL_L(n,m) to the pixel-of-interest one line before the pixel-of-interest by the threshold value calculation unit 31 (1301) of FIG. 13 from the edge 1 and the processing is completed at the edge 4.

Specifically, at the clock edge 1, the binarization result storage memory (1302) sends the binarization result data for the lines before the pixel-of-interest.

Thereafter, the multiplication circuit 31 (1307), the multiplication circuit 32 (1308), and the multiplication circuit 33 (1309) of FIG. 13 multiply the respective pixels with the coefficient. The multiplication is flip-flopped by the FF31 (1310), the FF32 (1311), and the FF33 (1312) respectively at the timing of the clock edge 2.

The data flip-flopped by the FF31 (1310), the FF32 (1311), and the FF33 (1312) is inputted to the addition circuit 31 (1313) of FIG. 13 and Ssum_L is calculated.

The data Ssum_L is flip-flopped by the FF34 (1314) at the timing of the clock edge 3.

The data flip-flopped by the FF34 (1314) is inputted to the division circuit 31 (1315) of FIG. 13 and the threshold value SL_L(n,m) to the lines before the pixel-of-interest is calculated.

The data SL_L(n,m) is flip-flopped by the FF35 (1316) at the timing of the clock edge 4 and the result is outputted from the threshold value calculation unit 31 (1301).

The processing of the threshold value SL_{—}1 (n,m) to the pixel one pixel before the pixel-of-interest in the threshold value calculation unit 32 (1321) of FIG. 13 is completed at the edge 4.

Specifically, at the timing of the clock edge 3, various pieces of data required for the threshold value calculation unit 32 (1321) are inputted. Then, the multiplication circuit 35 (1324) and the division circuit 32 (1325) perform the operation processing to calculate the value of SL_{—}1(n,m).

The value of SL_{—}1(n,m) is flip-flopped by the FF36(1326) at the timing of the clock edge 4 and the result is outputted from the threshold value calculation unit 32 (1321).

The processing of the threshold value SL_{—}2(n,m) to the pixel-of-interest to the pixel two pixels before the pixel-of-interest in threshold value calculation unit 33 (1318) of FIG. 13 is completed at the edge 4.

Specifically, at the timing of the clock edge 3, the weighting coefficient for the threshold value calculation required for the threshold value calculation unit 33 (1318) and the data for the binarization result outputted from the binarization processing unit 3 (1332) are inputted and the operation processing by the multiplication circuit 34 (1319) is performed. This operation processing calculates SL_{—}2(n,m).

The value of SL_{—}2(n,m) is flip-flopped by the FF37 (1320) at the timing of the clock edge 4 and the result is outputted from the threshold value calculation unit 33 (1318).

SL_L(n,m), SL_{—}1(n,m), and SL_{—}2(n,m) outputted at the timing of the clock edge 4 are inputted to the threshold value calculation unit 34 (1327).

The processings described hereinafter are performed within one cycle from the clock edge 4 to the edge 5.

The selector 31 (1329) selects, based on the processing result of the binarization of the pixel one pixel before the pixel-of-interest outputted at the timing of the edge 4, any of SL_{—}1(n,m) and the threshold value “0” (1328).

The threshold value SL_{—}2(n,m) to the pixel two pixels before the pixel-of-interest is inputted to the threshold value calculation unit 34 (1327) and the result is subjected to the division processing by the division circuit 33 (1330) to output the multiplication and division result SL_{—}3 (n,m) for the pixel two pixels before the pixel-of-interest.

The addition circuit 32 (1331) adds the data selected by the selector 31 (1329), SL_L(n,m) inputted to the threshold value calculation unit 34 (1327), and SL_{—}3 (n,m) to calculate the threshold value SL(n,m) to the pixel-of-interest.

In parallel with the above processing, the binarization processing unit 3 (1332) of FIG. 13 subjects Din(n,m) to the error compensation to the pixel-of-interest based on Er(n−1,m) and Ed(n,m−1).

Then, the threshold value to the pixel-of-interest SL(n,m) calculated by the above processing is compared with the error compensation data D(n,m) of the pixel-of-interest and the pixel-of-interest is binarized at the rising of the clock edge 5 and the result is outputted from the binarization processing unit 3 (1332).

As described above, the weighted operation of the lines before the pixel-of-interest is processed in the multi-cycle manner so as to be completed at the timing at which the processing of the pixel one pixel before the pixel-of-interest is performed.

Specifically, the weighted operation of the pixel-of-interest in the line before the pixel-of-interest is performed over a plurality of cycles by starting the weighted operation at an early stage to thereby reduce the load of the operation for the processing of the pixel-of-interest.

The multiplication and division of the pixel two pixels before the pixel-of-interest that is in the same line as that of the pixel-of-interest the precedent coefficient are performed in the multi-cycle manner so as to be completed at the timing at which the processing of the pixel one pixel before the pixel-of-interest is performed.

Specifically, the multiplication and division of the pixel two pixels before the pixel-of-interest that is in the same line as that of the pixel-of-interest are also processed over a plurality of cycles by starting the operation at an early stage to thereby reduce the load of the operation for the processing of the pixel-of-interest.

Furthermore, the multiplication and division operations of the pixel one pixel before the pixel-of-interest with the coefficient are performed in advance at the timing at which the pixel two pixels before the pixel-of-interest are processed by assuming a case where the pixel one pixel before the pixel-of-interest has a processing result of “1” and a case where the pixel one pixel before the pixel-of-interest has a processing result of “0”. Then, when the binarization result of the pixel one pixel before the pixel-of-interest is obtained, the above operation result is selected and used for the subsequent processing.

Specifically, the multiplication and division operations of the pixel one pixel before the pixel-of-interest with the coefficient are completed in advance by assuming both of the binarization results of the pixel one pixel before the pixel-of-interest, thereby reducing the load of the operation for the processing of the pixel-of-interest.

Furthermore, regarding the power-of-two division or multiplication operation as in the processing by the error distribution unit 3, the operation circuit is not prepared and the bit shift is used to thereby reduce the operation load.

This can consequently realize the processing by the hardware based on the average density storage method with a higher speed.

### Third Embodiment

In the first embodiment and the second embodiment, among the quantization based on the average density storage method, the embodiments have been described based on the binarization processing.

In the third embodiment, among the quantization based on the average density storage method, the multivaluing processing is performed by the hardware.

The third embodiment will be described together with the conventional technique when the multivalued processing is performed among the quantization based on the average density storage method.

First, the following section will describe in detail the average density storage method according to the conventional technique with regard to the three processings such as the threshold value calculation processing, the binarization processing, and the error distribution processing.

### <Average Density Storage Method in Conventional Technique>

In this embodiment and the conventional technique, the four-valuing process assumes that the minimum output value (output density 1) is “0” and the maximum output value (output density 4) is “255”.

Then, the other two output values are set, in an order of the thinner one, “85” (output density 2) and “170” (output density 3).

The multivaluing processing based on the average density storage method according to the conventional technique is as shown below.

### <Threshold Value Calculation Processing>

When N-valuing (N>1 (N is an integer of 2 or more) is performed in the threshold value calculation processing, N−1 types of threshold values are set.

In this case, the binarization results for the pixels before the pixel-of-interest for which the binarization is already completed are used to calculate one threshold value to the pixel-of-interest and, based on the threshold value, N−1 types of threshold values are generated.

### <Four-Valuing Processing>

The pixel-of-interest image data is subjected to the error compensation by the N-valuing error of the precedent pixel and is subsequently compared with the threshold value.

In this case, depending on threshold values among a plurality of threshold values that have therebetween the value of the image data after the error compensation, the value of N values to be outputted is determined.

### <Error Distribution Processing>

The error caused in the N-valuing (a difference between the output value and the image data after the error compensation) is subsequently given to the to-be-processed image data as an error compensation value.

### <Threshold Value Calculation Processing According to Conventional Technique>

When assuming that the pixel-of-interest subjected to the four-valuing processing is (n,m), the pixels in the line m before n−1 already have 4-value image data (“0”, “85”, “170”, or “255”) for which the four-valuing processing is already completed.

Similarly, the lines before the line m−1 also has the 4-value image data for which the four-valuing processing is already completed.

In the threshold value calculation processing, the four-valuing result of the pixels before the pixel-of-interest for which the four-valuing processing is already completed is subjected to the weighted operation to calculate the threshold value of the pixel-of-interest.

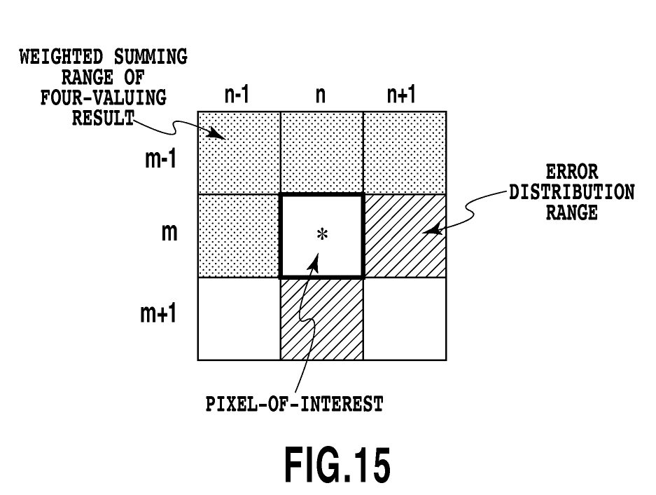

Next, with reference to FIG. 15, the following section will describe in detail the range of pixels used to calculate the threshold value.

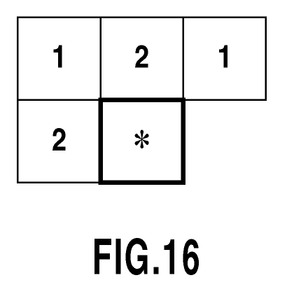

The range of pixels used to calculate the threshold value is assumed as the range of the four pixels of (n−1,m−1), (n,m−1), (n+1,m−1), and (n−1,m) as shown in FIG. 15. The weighting coefficients to the respective pixels are set, as shown in FIG. 16, so that “1” to (n−1,m−1), “2” to (n,m−1), “1” to (n+1,m−1), and “2” to (n−1,m).

The output values of the four-valuing processing result of the pixels before the pixel-of-interest are subjected to the weighted operation processing based on the above weighting coefficient.

Thus, the threshold value SL(n,m) to the pixel-of-interest (n,m) is calculated by performing the weighted operation processing as shown below.

First, the multiplication with the coefficients for the respective pixels is performed in the manner as shown below.

S(n−1,m−1)=the weighting coefficient of (n−1,m−1)×the four-valuing processing result value of (n−1,m−1)

S(n,m−1)=the weighting coefficient of (n,m−1)×the four-valuing processing result value of (n,m−1)

S(n+1,m−1)=the weighting coefficient of (n+1,m−1)×the four-valuing processing result value of (n+1,m−1)

S(n−1,m−1)=the weighting coefficient of (n−1,m)×the four-valuing processing result value of (n−1,m)

Ssum(n,m)=S(n−1,m−1)+S(n,m−1)+S(n+1,m−1)+S(n−1,m)

The following section will describe the compensation of the sum of the multiplication results of the respective pixels with coefficients.

The threshold value SL(n,m) to the pixel-of-interest (n,m) is calculated by the weighted operation processing as shown below.

SL(n,m)=Ssum(n,m)/{the weighting coefficient of (n−1,m−1)+the weighting coefficient of (n,m−1)+the weighting coefficient of (n+1,m−1)+the weighting coefficient of (n−1,m)}

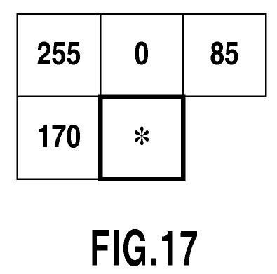

Thus, when the four-valuing processing result of the pixels before the pixel-of-interest is as shown in FIG. 17, the threshold value SL(n,m) to the pixel-of-interest is calculated by the weighted operation processing as shown below.

SL(n,m)={(1×255)+(2×0)+(1×85)+(2×170)}/(1+2+1+2)=133

Next, based on the threshold value SL(n,m) to the pixel-of-interest (n,m), N−1 types of threshold values for performing the N-valuing are generated.

In order to perform the four-valuing processing, three types of threshold values are generated. Then, the previously-set number “α” is added to and subtracted from the threshold value SL(n,m) to the pixel-of-interest (n,m) to thereby generate the three types of threshold values.

For example, the three types of threshold values can be, in an order from a smaller value, SL_Lo (n,m), SL_Md(n,m), and SL_Hi(n,m).

Thus, when the four-valuing processing result of the pixels before the pixel-of-interest is as shown in FIG. 17 and when the value of the threshold value SL(n,m) to the pixel-of-interest is “133” and the value “α” is set to “50”, the respective three types of threshold values are values as shown below.

SL_Lo(n,m)=133−50=83

SL_Md(n,m)=133

SL_Hi(n,m)=133+50=183

### <Four-Valuing Processing According to Conventional Technique>

The pixel-of-interest image data is subjected to the error compensation based on the N-valuing error of the precedent pixels and is then compared with the threshold value, thereby performing the N-valuing processing.

In this four-valuing processing, as shown in FIG. 15, the error data from the pixel in the pixel-of-interest line one pixel before the pixel-of-interest ad the error data from the pixel that is in the line one line before the pixel-of-interest and that is at the same position as that of the pixel-of-interest are added to the pixel-of-interest input data.

First, the pixel-of-interest input data is assumed as Din(n,m), binarization processing error data for the pixel in the pixel-of-interest line one pixel before the pixel-of-interest is assumed as Er(n−1,m), and the binarization processing error data for the pixel that is in the line one line before the pixel-of-interest and that is at the same position as that of the pixel-of-interest is assumed as Ed(n,m−1).

In this case, the data D(n,m) after the error compensation is calculated by the operation as shown below.

D(n,m)=Din(n,m)+Er(n−1,m)+Ed(n,m−1)

When Din(n,m)=121, Er(n−1,m)=14, and Ed(n,m−1)=−8 for example, the result is D(n,m)=121+14+(−8)=127. The error data Er and Ed will be described later.

The N-valuing processing compares the data D(n,m) after the error compensation with the previously-calculated N−1 types of threshold values to the pixel-of-interest to judge which output density is used to output a color to the pixel-of-interest, thereby outputting the N-valuing result N(n.m).

In the case of the four-valuing processing for example, the data D(n,m) after the error compensation is compared with the previously-calculated three types of threshold values SL_Lo(n,m), SL_Md(n,m), and SL_Hi(n,m) to the pixel-of-interest. Then, which density among the output density 1 to the output density 4 is used to output a color to the pixel-of-interest is judged, thereby outputting the four-valuing result N(n,m).

The above judgment is performed in the manner shown below.

Specifically, in the case of D(n,m)≦SL_Lo(n,m), it is judged to output the output density 1, resulting in N (n,m)=0. In the case of SL_Lo(n,m)<D(n,m)≦SL_Md(n,m), it is judged to output the output density 2, resulting in N(n,m)=85. In the case of SL_Md(n,m)<D(n,m)≦SL_Hi(n,m), it is judged to output the output density 3, resulting in N(n,m)=170. In the case of D(n,m)>SL_Hi(n,m), it is judged to output the output density 4, resulting in N(n,m)=255.

Specifically, in the case of D(n,m)=127, the threshold values to the pixel-of-interest are SL_Lo(n,m)=83, SL_Md(n,m)=133, and SL_Hi(n,m)=183, respectively. Thus, SL_Lo(n,m)<D(n,m)≦SL_Md(n,m) is established and thus it is judged to output the output density 2.

Specifically, the four-valuing output result is N(n,m)=85.

### <Error Distribution Processing According to Conventional Technique>

Next, in the error distribution processing, a difference between the data after the error compensation and the N-valuing output value is assumed as an N-valuing error to distribute the N-valuing error to the subsequent processing pixel.

E(n,m)=D(n,m)−N(n,m)

In the error distribution processing, as shown in FIG. 15, the error data is distributed to the pixel in the pixel-of-interest line at a position moved to the right side of the pixel-of-interest by one pixel and the pixel that is at a position one line lower than the pixel-of-interest and that is at the same position as that of the pixel-of-interest.

Here, the error data distributed to the pixel in the pixel-of-interest line at a position moved to the right side of the pixel-of-interest by one pixel is assumed as Er(n,m) and the error data distributed to the pixel that is at a position one line lower than the pixel-of-interest and that is at the same position as that of the pixel-of-interest is assumed as Ed(n,m).

Then, ½ of the error is distributed to the two parts of the pixel in the pixel-of-interest line at a position moved to the right side of the pixel-of-interest by one pixel and the pixel that is at a position one line lower than the pixel-of-interest and that is at the same position as that of the pixel-of-interest. Specifically, Er(n,m)=E(n,m)/2 and Ed(n,m)=E(n,m)/2 are established.

Then, the error data E(n,m) is calculated in the manner as shown below.

E(n,m)=D(n,m)−N(n,m)=127−85=42

In this case, Er(n,m)−E(n,m)/2=42/2=21 is established and Ed(n,m)=E(n,m)/2=42/2=21 is established.

The respective pieces of error data for the pixel-of-interest are used for the error compensation of Din(n+1,m) in the case of Er(n,m) and are used for the error compensation of Din(n,m+1) in the case of Ed(n,m).

Next, the following section will describe in detail the hardware in the conventional technique of the four-valuing processing.

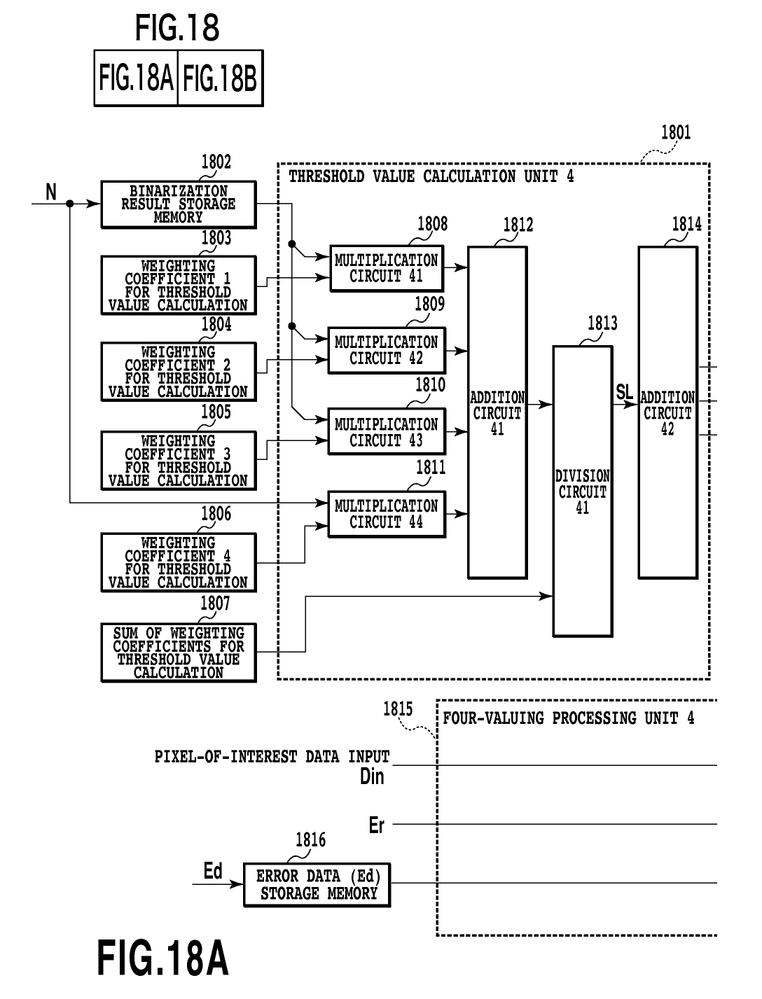

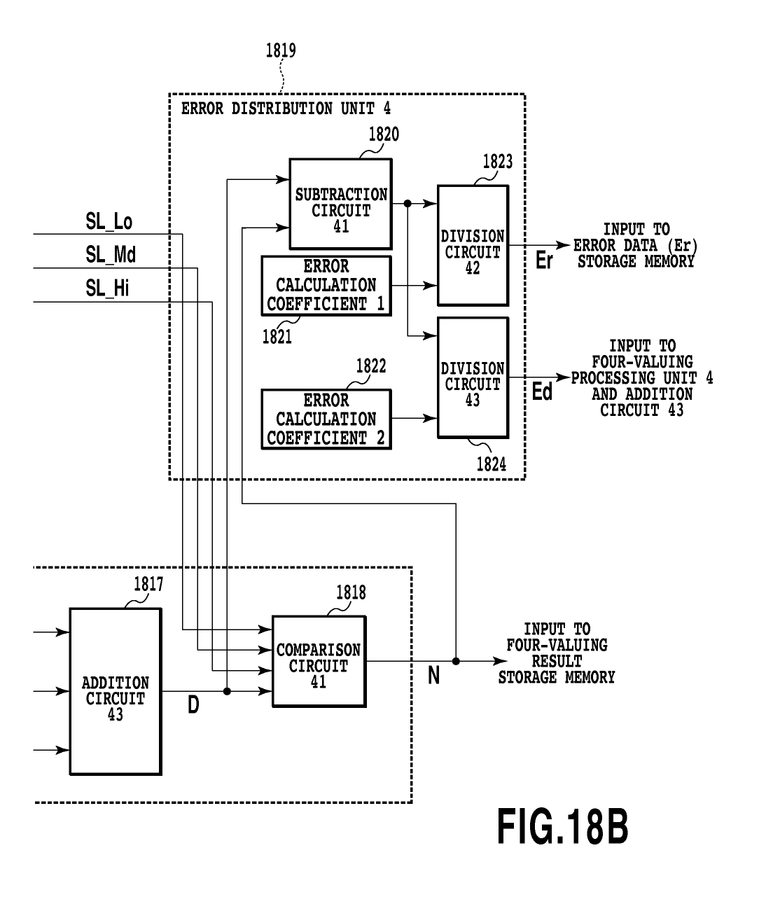

The hardware for realizing the four-valuing average density storage method in the conventional technique is shown in FIG. 18.

The following section will describe in detail the threshold value calculation unit 4 (1801).

Regarding the line m−1, the four-valuing processing is already completed and the 4-value image data exists.

These pieces of four-valuing result data are stored in the four-valuing result storage memory (1802).

In the threshold value calculation unit 4 (1801), the weighted operation is performed to the four-valuing result of the pixels before the pixel-of-interest for which the four-valuing processing is already completed to thereby calculate the threshold value of the pixel-of-interest.

With reference to FIG. 18, the details will be described hereinafter.

The Weighting coefficient 1 for threshold value calculation (1803) stores therein, by a memory for example, the weighting coefficient of (n−1,m−1).

The Weighting coefficient 2 for threshold value calculation (1804) stores therein, by a memory for example, the weighting coefficient of (n,m−1).

The Weighting coefficient 3 for threshold value calculation (1805) stores therein, by a memory for example, the weighting coefficient of (n+1,m−1).

The Weighting coefficient 4 for threshold value calculation (1809) stores therein, by a memory for example, the weighting coefficient of (n−1,m).

The sum of the weighting coefficients for the threshold value calculation stores therein, by a memory for example, the sum of the weighting coefficients of (n−1,m−1), (n,m−1), (n+1,m−1), and (n−1,m).

The four-valuing result storage memory (1802) outputs the four-valuing result data of the three pixels of (n−1,m−1), (n,m−1), and (n+1,m−1). Then, the data for the respective four-valuing results is multiplied with the weighting coefficient of (n−1,m−1), the weighting coefficient of (n,m−1), and the weighting coefficient of (n+1,m−1) by the multiplication circuit 41 (1808), the multiplication circuit (1809), and the multiplication circuit 43 (1810), respectively.

Regarding the binarization result of (n−1,m), the four-valuing result N outputted in the previous processing is directly inputted to the multiplication circuit 44 (1811) and the multiplication with the weighting coefficient of (n−1,m) stored in Weighting coefficient 4 for threshold value calculation (1806) is performed.

In the calculation of the sum of the multiplication results with the weighting coefficients for the respective pixels, the output values from the multiplication circuit 41 (1808), the multiplication circuit 42 (1809), the multiplication circuit 43 (1810), and the multiplication circuit 44 (1811) are inputted to the addition circuit 41 (1812). Then, the addition circuit 41 (1812) calculates the sum Ssum(n,m) of the multiplication results with the weighting coefficients for the respective pixels.

The division circuit 41 (1813) divides the sum Ssum(n,m) of the multiplication results with the weighting coefficients for the respective pixels outputted from the addition circuit 41 (1812) by the value stored in the sum (1807) of the weighting coefficients for the threshold value calculation to thereby calculate the threshold value SL(n,m) to the pixel-of-interest.

The addition circuit 42 (1814) adds the coefficients for generating a plurality of threshold values (“α” and “−α” in the case of this example) to the threshold value SL(n,m) to the pixel-of-interest, respectively, to thereby output SL_Lo(n,m), SL_Md(n,m), and SL_Hi(n,m).

In this case, as the respective threshold values, the values of SL_Lo(n,m)=SL(n,m)+(−α), SL_Md(n,m)=SL(n,m), and SL_Hi(n,m)=SL(n,m)+α are outputted.

### <Four-Valuing Processing Unit 4 (1815)>

The four-valuing processing unit 4 (1815) compares the pixel-of-interest image data subjected to the error compensation based on the four-valuing error of the pixels before the pixel-of-interest with the threshold value calculated by the threshold value calculation unit 4 (1801) to perform the four-valuing processing.

Er(n−1,m) is error data that is outputted from the error distribution unit 4 (1819) (which will be described later) and that is calculated based on the four-valuing result of the pixel one pixel before the pixel-of-interest.

The error data (Ed) storage memory (1816) stores therein the error data regarding Ed(n,m−1) among the four-valuing error of the pixels before the pixel-of-interest.

The error data Er and Ed will be described later.

The four-valuing processing unit 4 (1815) receives the following three pieces of data as shown in FIG. 18.

Specifically, Din(n,m), Er(n−1,m), and Ed(n,m−1) are inputted to the four-valuing processing unit 4 (1815). Here, Din(n,m) is the pixel-of-interest input data. Er(n−1,m) is four-valuing processing error data for the pixel in the pixel-of-interest line one pixel before the pixel-of-interest. Ed(n,m−1) is four-valuing processing error data for the pixel that is in the line one line before the pixel-of-interest and that is at the same position as that of the pixel-of-interest.

The addition circuit 43 (1817) adds the above three pieces of data to calculate the data D(n,m) after the error compensation of the pixel-of-interest.

Next, the comparison circuit 41 (1818) of the four-valuing processing unit 4 (1815) compares D(n,m) with the threshold values SL_Lo(n,m), SL_Md(n,m), and SL_Hi(n,m). Then, the comparison circuit 41 (1818) judges which output density is used to output a color to the pixel-of-interest to output the N-valuing result N(n,m).

The comparison circuit 41 (1818) judges N(n,m) in the manner as shown below. Specifically, in the case of D(n,m)≦SL_Lo(n,m), the comparison circuit 41 (1818) judges to output the output density 1 to judge N(n,m)=0. In the case of SL_Lo(n,m)<D(n,m)≦SL_Md(n,m), the comparison circuit 41 (1818) judges to output the output density 2 to judge N (n,m)=85. In the case of SL_Md(n,m)<D(n,m)≦SL_Hl(n,m), the comparison circuit 41 (1818) judges to output the output density 3 to judge N (n,m)=170. In the case of D(n,m)>SL_Hi (n,m), the comparison circuit 41 (1818) judges to output the output density 4 to judge N(n,m)=255.

The four-valuing result N(n,m) of the pixel-of-interest outputted from the comparison circuit 41 (1818) is inputted to the four-valuing result storage memory (1802) and the multiplication circuit 44 (1811) of the threshold value calculation unit 4 (1801), respectively.

The data stored in the four-valuing result storage memory (1802) is used to calculate the threshold value at the four-valuing processing of the line next to the line already subjected to the four-valuing processing.

The data inputted to the multiplication circuit 44 (1811) of the threshold value calculation unit 4 (1801) is used to calculate the threshold value at the four-valuing processing of the pixel of next to the pixel already subjected to the four-valuing processing.

### <Error Distribution Unit 4 (1819)>

The error distribution unit 4 (1819) distributes the difference to the data D(n,m) after the error compensation of the pixel-of-interest and the pixel-of-interest N(n,m) calculated by the four-valuing processing unit 4 (1815) as the four-valuing error E(n,m) to distribute the four-valuing error E(n,m) to the to-be-processed pixel.

The subtraction circuit 41 (1820) calculates E(n,m) that is a difference between the data D(n,m) after the error compensation of the pixel-of-interest and the pixel-of-interest N(n,m) calculated by the four-valuing processing unit 4 (1815).

In the processing performed by the error distribution unit 4 (1819), as shown in FIG. 15, the error data is distributed to the pixel in the pixel-of-interest line at a position moved to the right side of the pixel-of-interest by one pixel and the pixel that is at a position one line lower than the pixel-of-interest and that is at the same position as that of the pixel-of-interest.

Here, the error data distributed to the pixel in the line of the pixel-of-interest (n,m) at a position moved to the right side of the pixel-of-interest by one pixel is assumed as Er(n,m) and the error data distributed to the pixel that is at a position one line lower than the pixel-of-interest (n,m) and that is at the same position as that of the pixel-of-interest is assumed as Ed(n,m). Then, the error data is distributed to the respective pixels at the right side and the lower side of the pixel-of-interest (n,m).

Then, ½ of the error data is distributed to the two parts of the pixel in the pixel-of-interest line at a position moved to the right side of the pixel-of-interest by one pixel and the pixel that is at a position one line lower than the pixel-of-interest and that is at the same position as that of the pixel-of-interest.

The error data Er(n,m) distributed to the pixel in the line of the pixel-of-interest (n,m) at a position moved to the right side of the pixel-of-interest by one pixel is calculated by the division circuit 42 (1823).

The error data Ed(n,m) distributed to the pixel that is at a position one line lower than the pixel-of-interest (n,m) and that is at the same position as that of the pixel-of-interest is calculated by the division circuit 43 (1824).

Here, the error calculation coefficient 1 (1821) stores therein a coefficient for calculating Er(n,m) based on the four-valuing error E(n,m). The coefficient for calculating Er(n,m) based on the four-valuing error E(n,m) is read out from the error calculation coefficient 1 (1821) and is inputted to the division circuit 42 (1823).

The error calculation coefficient 2 (1822) stores therein a coefficient for calculating Ed(n,m) based on the four-valuing error E(n,m). The coefficient for calculating Ed(n,m) based on the four-valuing error E(n,m) is read out from the error calculation coefficient 2 (1822) and is inputted to the division circuit 43 (1824).

The error data Ed(n,m) distributed to the pixel that is at a position one line lower than the pixel-of-interest (n,m) and that is at the same position as that of the pixel-of-interest is inputted to the error data (Ed) storage memory (1816).

The error data Er(n,m) distributed to the pixel in the line of the pixel-of-interest (n,m) at a position moved to the right side of the pixel-of-interest by one pixel is inputted to the addition circuit 43 (1817) of the four-valuing processing unit 4 (1815).

The error data (Ed(n,m)) stored in the error data (Ed)storage memory (1816) is used for the error compensation by the four-valuing processing unit 4 (1815) at the four-valuing processing to the line following the line of the pixel-of-interest (n,m).

The error data (Er(n,m)) inputted to the addition circuit 43 (1817) of the four-valuing processing unit 4 (1815) is used for the error compensation by the four-valuing processing unit 4 (1815) at the four-valuing processing to the pixel following the pixel-of-interest (n,m).

### <Disadvantage in Conventional Technique>

In order to output the processing result of the average density storage method like the above example in a manner of one pixel per one clock, all processings of the threshold value calculation processing, the N-valuing processing, and the error distribution processing must be completed within one clock.

In the current situation, the multiplication, addition, and division, for the threshold value calculation processing and the subtraction and division for the error distribution processing must be performed sequentially.

Furthermore, an improved image quality causes an increased gray level number of image data causing an increased bit number of image data, an expanded area for the weighted operation processing for the threshold value calculation, and an expanded area for the error distribution for example, thus causing an increased operational load required for the average density storage method than ever before.

Due to this reason, when an operation at an early frequency is to be performed, various operation processings are not completed within one clock, thus causing a problem of preventing a high-speed operation from being performed.

Thus, the following processing is performed in the third embodiment.

Regarding the weighted operation for calculating the threshold value for processing the pixel-of-interest, the processing as shown below is performed.

The weighted operation of the pixel-of-interest in the line before the pixel-of-interest is performed in the multi-cycle manner so as to be completed at the timing at which the processing of the pixel one pixel before the pixel-of-interest is performed.

Specifically, the weighted operation of the pixel-of-interest in the line before the pixel-of-interest is started sooner so that the weighted operation is performed over a plurality of cycles to thereby reduce the load of the operation for the processing of the pixel-of-interest.

The multiplication and division of the pixel one pixel before the pixel-of-interest with the coefficient are computed in advance at the timing of the processing of the pixel two pixels before the pixel-of-interest while assuming a case where the pixel one pixel before the pixel-of-interest has a processing result of “255”, a case where the pixel one pixel before the pixel-of-interest has a processing result of “170”, a case where the pixel one pixel before the pixel-of-interest has a processing result of “85”, and a case where the pixel one pixel before the pixel-of-interest has a processing result of “0”, respectively. Then, when the result of the binarization of the pixel one pixel before the pixel-of-interest is obtained, the above operation result is selected and is used for the subsequent processing.

Specifically, for the multiplication and division of the pixel one pixel before the pixel-of-interest with the coefficient, the operation assuming all outputs of the four-valuing results of the pixel one pixel before the pixel-of-interest is completed in advance to thereby reduce the load of the operation for the processing of the pixel-of-interest.

Next, the third embodiment will be described in detail.

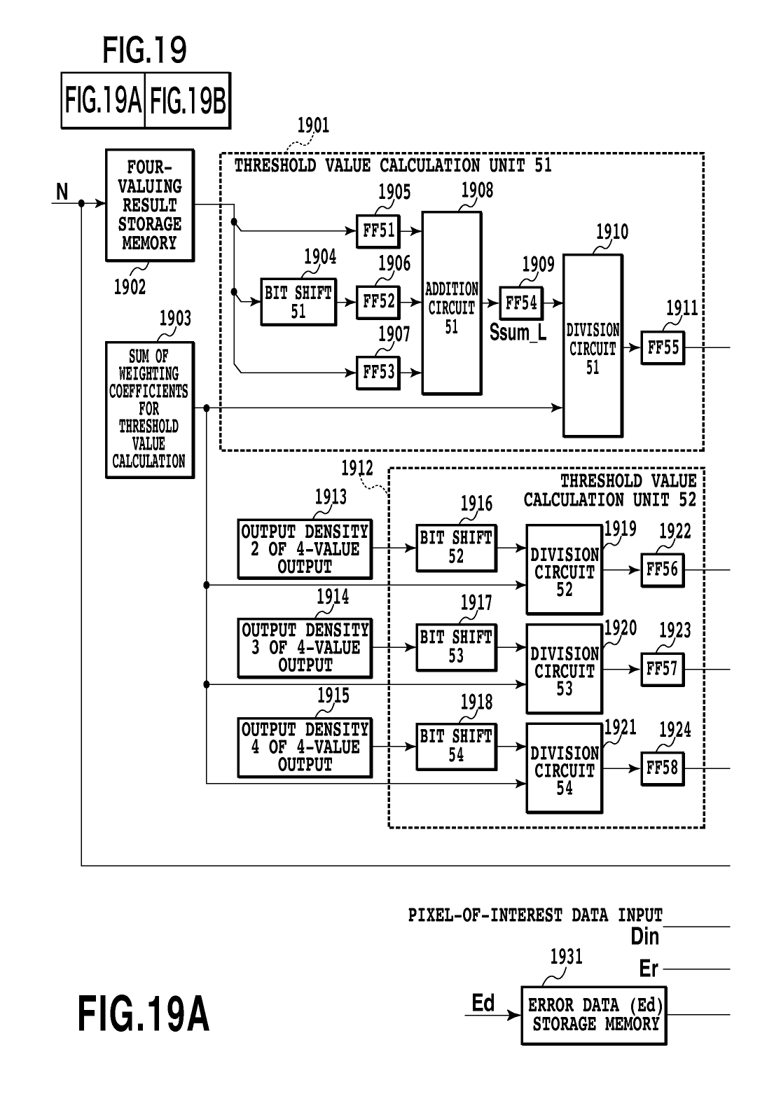

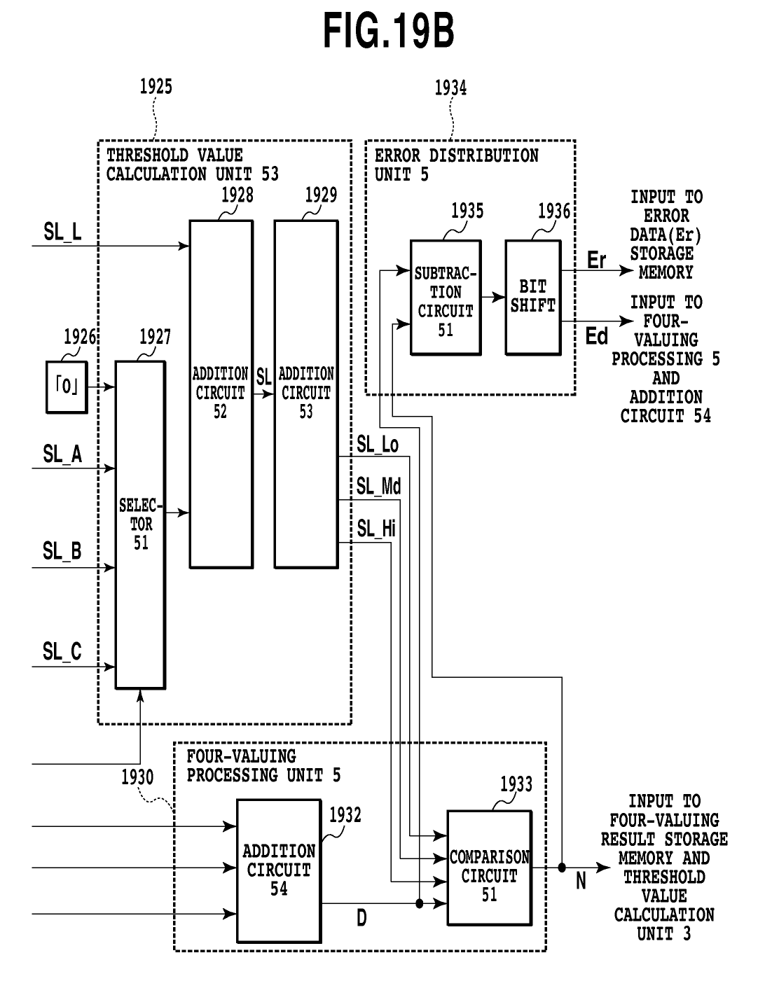

The hardware for realizing the average density storage method in the third embodiment is shown in FIG. 19.

### <Threshold Value Calculation Unit 51 (1901)>

Regarding the line m−1, the four-valuing processing is already completed and the 4-value image data exists.

These pieces of four-valuing result data are stored in the four-valuing result storage memory (1902).

The threshold value calculation unit 51 (1901) performs the weighted operation to the four-valuing result of the pixels before the pixel-of-interest for which the four-valuing processing is completed to perform the weighted operation to the line before the pixel-of-interest in particular.

In this case, when the weighted operation is performed in the conventional technique, the weighting coefficient is stored in advance in a memory for example and the weighting coefficient is multiplied with the four-valuing result.

However, since this embodiment uses the weighting coefficients as shown in FIG. 16, regarding the multiplication of the pixel having a weighting coefficient of “1”, the value of the four-valuing result is outputted to be directly used as an input to the next processing. Then, regarding the multiplication of the pixel having a weighting coefficient of “2”, one bit is shifted and the same value as that obtained by the multiplication with “2” is outputted as an input to the next processing.

This can consequently eliminate the need to prepare a complicate multiplication circuit and can reduce the operation load, thus realizing the processing with a higher speed.

Specifically, the processing as shown below is performed.

The weighting coefficient 1 for calculating the threshold value of (n−1,m−1) is “1”. Thus, the weighting coefficient is directly inputted to the next addition circuit 51 (1908).

The weighting coefficient 2 for calculating the threshold value of (n,m−1) is “2”. Thus, the bit shift 51 (1904) performs one bit shift and the weighting coefficient is inputted to the next addition circuit 51 (1908).

The weighting coefficient 1 for calculating the threshold value of (n+1,m−1) is “1”. Thus, the weighting coefficient is directly inputted to the next addition circuit 51 (1908).

The addition circuit 51 (1908) adds the respective input values to calculate the sum Ssum_L of the result of the multiplication of the respective pixels in the line before the pixel-of-interest with the coefficients.

The sum (1903) of the weighting coefficients for the threshold value calculation stores therein the sum of the weighting coefficients of (n−1,m−1), (n,m−1), (n+1,m−1), and (n−1,m).

The division circuit 51 (1910) divides the sum Ssum_L of the result of the multiplication of the respective pixels in the line before the pixel-of-interest with the coefficients outputted from the addition circuit 51 (1908) by the value stored in the sum (1903) of the weighting coefficients for the threshold value calculation. Then, division circuit 51 (1910) calculates, through this operation, the threshold value SL_L(n,m) to the pixel-of-interest one line before the pixel-of-interest.

### <Threshold Value Calculation Unit 52 (1912)>

The threshold value calculation unit 52 (1912) performs the multiplication and division with the coefficients of the four-valuing result of the pixels before the pixel-of-interest for which the four-valuing processing is already completed to thereby perform the multiplication and division with the coefficients of the pixel one pixel before the pixel-of-interest in particular.

The threshold value calculation unit 52 (1912) assumes, prior to the completion of the four-valuing processing of the pixel one pixel before the pixel-of-interest, the respective cases where the pixel one pixel before the pixel-of-interest has the four-valuing processing results of “0”, “85”, “170”, and “255” and performs in advance the multiplication and division with the coefficients of the pixel one pixel before the pixel-of-interest.

In this embodiment, when the pixel one pixel before the pixel-of-interest has a four-valuing processing result of the output density 2 (i.e., “85”), the result of the multiplication and division with the coefficients of the pixel one pixel before the pixel-of-interest is assumed as SL_A(n,m).

In this embodiment, when the pixel one pixel before the pixel-of-interest has a four-valuing processing result of the output density 3 (i.e., “170”), the result of the multiplication and division with the coefficients of the pixel one pixel before the pixel-of-interest is assumed as SL_B(n,m).

this embodiment, when the pixel one pixel before the pixel-of-interest has a four-valuing processing result of the output density 3 (i.e., “255”), the result of the multiplication and division with the coefficients of the pixel one pixel before the pixel-of-interest is assumed as SL_C(n,m).

In this embodiment, when the pixel one pixel before the pixel-of-interest has a binarization processing result of “0”, then the output when the processing equivalent to other output densitys performed by the threshold value calculation unit 52 (1912) is “0”. Thus, no particular operation circuit is used and the threshold value calculation unit 53 (1925) receives the value of “0” (1926) that is selected by the selector 51 (1927).

### <Threshold Value Calculation Unit 53 (1925)>

The threshold value calculation unit 53 (1925) is composed of: a selector 51 (1927), an addition circuit 52 (1928), and an addition circuit 53 (1929).

The selector 51 (1927) selects any of a plurality of threshold values of SL_A(n,m), SL_B(n,m), SL_C(n,m), or “0” to input the value to the addition circuit 52 (1928).

In this case, the selector 51 (1927) selects “0” when the pixel one pixel before the pixel-of-interest has the four-valuing result N of “0”, SL_A(n,m) when the pixel one pixel before the pixel-of-interest has the four-valuing result N of “85”, SL_B(n,m) when the pixel one pixel before the pixel-of-interest has the four-valuing result N of “170”, and SL_C(n,m) when the pixel one pixel before the pixel-of-interest has the four-valuing result N of “255”.

The addition circuit 52 (1928) adds the previously-calculated threshold value SL_L(n,m) to the pixel-of-interest for the line before the pixel-of-interest to the output value from the selector 51 (1927) to calculate the threshold value SL(n,m) to the pixel-of-interest.

The addition circuit 53 (1929) adds a plurality of coefficients for generating threshold values (“α” and “−α” in the case of this embodiment) to the threshold value SL(n,m) to the pixel-of-interest, respectively to output SL_Lo(n,m), SL_Md(n,m), and SL_Hi(n,m).

In this case, the respective threshold values of SL_Lo(n,m)=SL(n,m)+(−α), SL_Md(n,m)=SL(n,m), and SL_Hi(n,m)=SL(n,m)+α are outputted.

### <Four-Valuing Processing Unit 5 (1930)>

The four-valuing processing unit 5 (1930) compares, with regard to the pixel-of-interest image data, the pixel-of-interest image data subjected to the error compensation based on the four-valuing error of the pixels before the pixel-of-interest with the threshold value calculated by the threshold value calculation unit 53 (1925) to perform the four-valuing processing.

Er(n−1,m) is the error data that is outputted from an error distribution unit 5 (1934) (which will be described later) and that is calculated based on the four-valuing result of the pixel one pixel before the pixel-of-interest.

The error data (Ed) storage memory (1931) stores the error data related to Ed(n,m−1) among the four-valuing errors of the pixels before the pixel-of-interest.

The error data Er and Ed will be described later.

The four-valuing processing unit 5 (1930) receives the following three pieces of data as shown in FIG. 19.

Specifically, Din(n,m), Er(n−1,m), and Ed(n,m−1) are inputted to the four-valuing processing unit 5 (1930). Here, Din(n,m) is the pixel-of-interest input data. Er(n−1,m) is four-valuing processing error data of the pixel in the pixel-of-interest line one pixel before the pixel-of-interest. Ed(n,m−1) of the four-valuing processing error data of the pixel that is in the line one line before the pixel-of-interest and that is at the same position as that of the pixel-of-interest.

The addition circuit 54 (1932) adds the above three pieces of data to calculate the data D(n,m) after the error compensation of the pixel-of-interest.

Next, the comparison circuit 51 (1933) of the four-valuing processing unit 5 (1930) compares D(n,m) with the threshold value SL_Lo(n,m), SL_Md(n,m), and SL_Hi(n,m) calculated by the threshold value calculation unit 53 (1925). Then, the comparison circuit 51 (1933) judges which output density is used to output a color to the pixel-of-interest to output the N-valuing result N(n,m).

The comparison circuit 51 (1933) makes a N(n,m)-related judgment in the manner as shown below.

Specifically, in the case of D(n,m)≦SL_Lo(n,m), the comparison circuit 51 (1933) judges to output the output density 1 to judge N(n,m)=0.

In the case of SL_Lo(n,m)<D(n,m)≦SL_Md(n,m), the comparison circuit 51 (1933) judges to output the output density 2 to judge N(n,m)=85.

In the case of SL_Md(n,m)<D(n,m)≦SL_Hi(n,m), the comparison circuit 51 (1933) judges to output the output density 3 to judge N(n,m)=170.

In the case of D(n,m)>SL_Hi(n,m), the comparison circuit 51 (1933) judges to output the output density 4 to judge N (n,m)=255.

The four-valuing result N(n,m) of the pixel-of-interest outputted from the comparison circuit 51 (1933) is inputted to the four-valuing result storage memory (1902) and the selector 51 (1927) of the threshold value calculation unit 53 (1925), respectively.

The data stored in the four-valuing result storage memory (1902) is used for the threshold value calculation at the four-valuing processing of a line following the line already subjected to the four-valuing processing.

The data inputted to the selector 51 (1927) of the threshold value calculation unit 53 (1925) is used for the threshold value calculation at the four-valuing processing of a pixel following the pixel already subjected to the four-valuing processing.

### <Error Distribution Unit 5 (1934)>

The error distribution unit 5 (1934) assumes a difference between the data D(n,m) after the error compensation of the pixel-of-interest and the pixel-of-interest N(n,m) as the four-valuing error E(n,m) and distributes the four-valuing error E(n,m) to the to-be-processed pixel.

The subtraction circuit 51 (1935) calculates the difference E(n,m) between the data D(n,m) after the error compensation of the pixel-of-interest calculated by the four-valuing processing unit 5 (1930) and the pixel-of-interest N(n,m).

In the processing performed by the error distribution unit 5 (1934), as shown in FIG. 15, the error data is distributed to the pixel in the pixel-of-interest line at a position moved to the right side of the pixel-of-interest by one pixel and the pixel that is at a position one line lower than the pixel-of-interest and that is at the same position as that of the pixel-of-interest.

Here, the error data distributed to the pixel in the line of the pixel-of-interest (n,m) at a position moved to the right side of the pixel-of-interest by one pixel is assumed as Er(n,m) and the error data distributed to the pixel that is at a position one line lower than the pixel-of-interest (n,m) and that is at the same position as that of the pixel-of-interest is assumed as Ed(n,m). Then, the error data is distributed to the respective pixels at the right side and at the lower side of the pixel-of-interest (n,m).

Then, ½ of the error data is distributed to the two parts of the pixel in the pixel-of-interest line at a position moved to the right side of the pixel-of-interest by one pixel and the pixel that is at a position one line lower than the pixel-of-interest and that is at the same position as that of the pixel-of-interest.

Thus, in this embodiment, for the purpose of reducing the operation processing, the value of E(n,m) as a difference between the data D(n,m) after the error compensation of the pixel-of-interest and the pixel-of-interest N(n,m) is not subjected to the processing by the division circuit. Instead, the bit shift (1936) is used to delete the least significant one bit of the data E(n,m). As a result, the same value as that obtained by dividing the data E(n,m) by 2 is outputted as Ed(n,m) and Er(n,m).

Then, Ed(n,m) is inputted to the error data (Ed) storage memory (1931).

Er(n,m) is inputted to the addition circuit 54 (1932) of the four-valuing processing unit 5 (1930).

The data stored in the error data (Ed) storage memory (1931) is used for the error compensation by the four-valuing processing unit 5 (1930) at the four-valuing processing to the line following the pixel-of-interest line.

The data inputted to the addition circuit 54 (1932) of the four-valuing processing unit 5 (1930) is used for the error compensation by the four-valuing processing unit 5 (1930) at the four-valuing processing to the pixel following the pixel-of-interest.

Next, the following section will describe in detail the clock and the processing timing in the third embodiment.

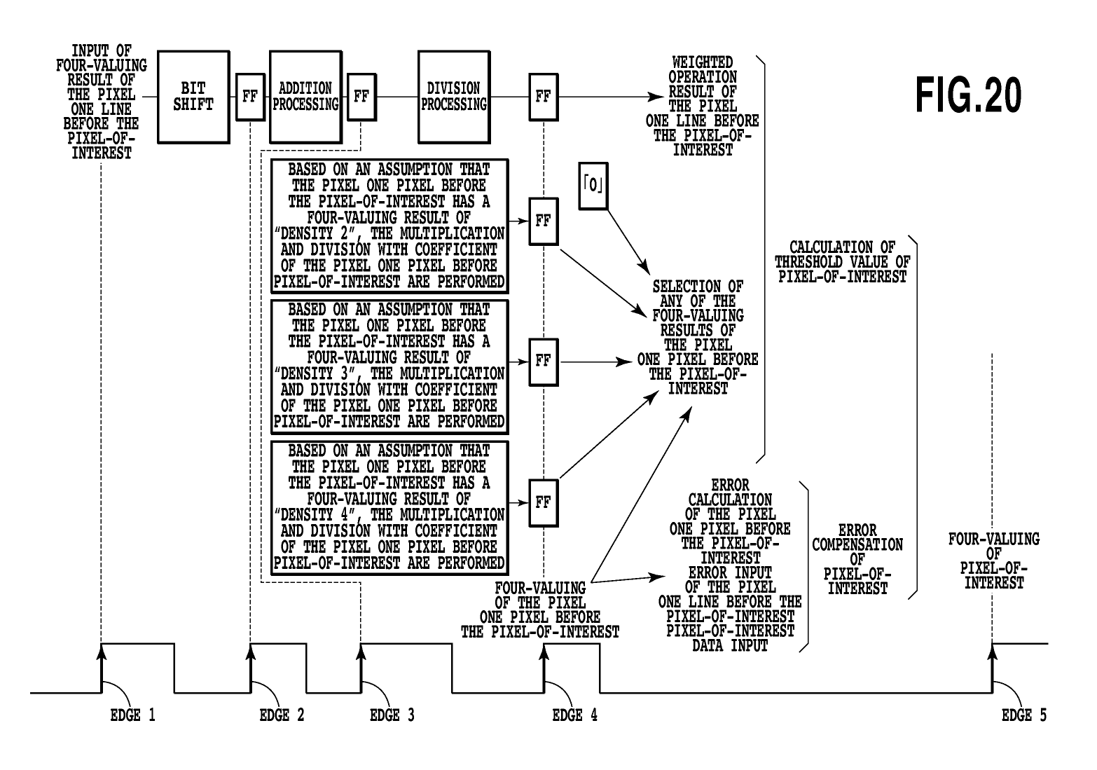

Specifically, with reference to FIG. 20, the following section will describe an order of performing the respective processings to the clock edge in this embodiment.

When the four-valuing of the pixel-of-interest is performed at the rising of the clock edge 5, the processing shown in FIG. 20 is performed.

The calculation of the threshold value SL_L(n,m) to the pixel-of-interest one line before the pixel-of-interest in the threshold value calculation unit 51 (1901) of FIG. 19 is started from the edge 1 and the processing is completed at the edge 4.

Specifically, at the clock edge 1, the data of the four-valuing result of the line before the pixel-of-interest is sent from the four-valuing result storage memory (1902).

Thereafter, the bit shift 51 (1904) of FIG. 19 performs the same processing as the multiplication with the coefficient. The result is flip-flopped, at the timing of the clock edge 2, by the FF51 (1905), FF52 (1906), and FF53 (1907), respectively.

The data flip-flopped by the FF51 (1905), FF52 (1906), and FF53 (1907) is inputted to the addition circuit 51 (1908) of FIG. 19 and Ssum_L is calculated.

The data Ssum_L is flip-flopped by the FF54 at the timing of the clock edge 3.

The data flip-flopped by the FF54 (1909) is inputted to the division circuit 51 (1910) of FIG. 19 to calculate the threshold value SL_L(n,m) to the pixel-of-interest for the line before the pixel-of-interest.

The data SL_L(n,m) is flip-flopped by the FF55 (1911) at the timing of the clock edge 4 and the result is outputted from the threshold value calculation unit 51 (1901).

The calculation processing of the respective threshold values SL_A(n,m), SL_B(n,m), and SL_C(n,m) to the pixel one pixel before the pixel-of-interest in the threshold value calculation unit 52 (1912) of FIG. 19 is completed at the edge 4.

Specifically, at the timing of the clock edge 3, the input of the respective pieces of data required for the threshold value calculation unit 52 (1912) is performed. Then, the operation processings of the bit shift 52 (1916), bit shift 53 (1917), bit shift 54 (1918), and division circuit 52 (1919), division circuit 53 (1920), and division circuit 54 (1921) are performed. Then, the respective values of SL_A(n,m), SL_B(n,m), and SL_C(n,m) are calculated.

The respective values of SL_A(n,m), SL_B(n,m), and SL_C(n,m) are flip-flopped, at the timing of the clock edge 4, by the FF58(1922), FF58(1923), and FF58(1924), respectively, and the result is outputted from the threshold value calculation unit 52 (1912).

Thereafter, the processing described is performed within one cycle from the clock edge 4 to the edge 5.

The selector 51 (1927) selects any of the threshold values SL_A(n,m), SL_B(n,m), and SL_C(n,m) as well as the threshold value “0” to the pixel-of-interest (1926) for the pixel one pixel before the pixel-of-interest assuming a case where the binarization result of the pixel one pixel before the pixel-of-interest is “0”. The selection by the selector 51 (1927) is based on the four-valuing processing result of the pixel one pixel before the pixel-of-interest outputted at the timing of the edge 4.

The addition circuit 52 (1928) adds the data selected by the selector 51 (1927) and SL_L(n,m) inputted to the threshold value calculation unit 53 (1925) to calculate the threshold value SL(n,m) to the pixel-of-interest.

Then, the addition circuit 53 (1929), adds, to the threshold value SL(n,m) to the pixel-of-interest, coefficients for generating a plurality of threshold values (“α” and “−α” in the case of this embodiment), respectively, to output SL_Lo(n,m), SL_Md(n,m), and SL_Hi(n,m).

In this case, as the respective threshold values, the values of SL_Lo(n,m)=SL(n,m)+(−α), SL_Md(n,m)=SL(n,m), and SL_Hi(n,m)=SL(n,m)+α are outputted.

At the same time, the four-valuing processing unit 5 (1930) of FIG. 19 subjects Din(n,m) to the error compensation to the pixel-of-interest based on Er(n−1,m) and Ed(n,m−1).

Then, the comparison circuit 51 (1933) compares D(n,m) with the threshold values SL_Lo(n,m), SL_Md(n,m), and SL_Hi(n,m). Then, the comparison circuit 51 (1933) judges which output density is used to output a color to the pixel-of-interest to output the N-valuing result N(n,m).

As described above, also regarding the multivalued quantization using the average density storage method, the weighted operation of the pixel-of-interest in the line before the pixel-of-interest is processed in the multi-cycle manner so as to be completed at the timing at which the processing of the pixel one pixel before the pixel-of-interest is performed.

Specifically, the weighted operation of the pixel-of-interest in the line before the pixel-of-interest is performed over a plurality of cycles by starting the weighted operation at an early stage to thereby reduce the load of the operation for the processing of the pixel-of-interest.

Furthermore, regarding the multiplication and division with the coefficient of the pixel one pixel before the pixel-of-interest, at the timing at which the pixel two pixels before the pixel-of-interest are processed, all patterns of the processing results of the pixel one pixel before the pixel-of-interest are assumed and the operation is performed in advance. Then, when the quantization result for the pixel one pixel before the pixel-of-interest is obtained, the operation result is selected and is used for the subsequent processing.

Specifically, regarding the multiplication and division with the coefficient of the pixel one pixel before the pixel-of-interest, the operations assuming both quantization results of the pixel one pixel before the pixel-of-interest are completed in advance to thereby reduce the load of the operation for the processing of the pixel-of-interest.

Furthermore, regarding the power-of-two division or multiplication operation as in the processing by the threshold value calculation unit 51, the threshold value calculation unit 52, and the error distribution unit 5, no operation circuit is prepared and bit shift is used, thereby reducing the operation load.

This can consequently realize the processing by the hardware based on the average density storage method with a higher speed.

By the above embodiment, the average density storage method can be performed even by, specifically, an old-generation process ASIC such as 130 nm process and the latest process ASIC such as 80 nm and 65 nm.

Furthermore, by the above embodiment, the latest process FPGA such as 65 nm process FPGA can be used to perform the average density storage method.

As a computer program for causing a computer to perform the method performed by the apparatus according to the invention described in the above section, the computer program may be recorded in a computer-readable recording medium.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-010182, filed Jan. 20, 2009, which is hereby incorporated by reference herein in its entirety.

What is claimed is:

1. An apparatus, comprising:
an N-valuing unit for N-valuing pixel data in the respective pixels included in an image to have a value of N (N is an integer of 2 or more) by using threshold values to the respective pixels to thereby obtain N-valuing results for the respective pixels; and
a calculation unit for calculating threshold values to the respective pixels,
wherein the calculation unit performs, prior to the respective pixels, a processing for multiplying with a coefficient the respective N-valuing results of a plurality of pixels by the N-valuing performed by the N-valuing unit to calculate the sum to thereby calculate the threshold value, and the N-valuing performed by the N-valuing unit of pixel data of a specific pixel of the plurality of pixels is not after the processing performed by the calculation unit of multiplying with the coefficient of an N-valuing result of pixel data of the specific pixel.

2. The apparatus according to claim 1, wherein in order to perform the processing by the calculation unit simultaneously with the N-valuing, the calculation unit assumes in advance an N-valuing result of pixel data of the specific pixel.

3. The apparatus according to claim 1, wherein the calculation unit assumes any N-valuing results for the pixel data of the specific pixel but does not assume a result in which the N-valuing result is 0.

4. A method, comprising:
an N-valuing step for N-valuing pixel data in the respective pixels included in an image to have a value of N (N is an integer of 2 or more) by using threshold values to the respective pixels to thereby obtain N-valuing results for the respective pixels; and
a calculation step for calculating threshold values to the respective pixels,
wherein the calculation step performs, prior to the respective pixels, a processing for multiplying with a coefficient the respective N-valuing results of a plurality of pixels by the N-valuing performed by the N-valuing step to calculate the sum to thereby calculate the threshold value and the N-valuing performed by the N-valuing step of pixel data of a specific pixel of the plurality of pixels is not after the processing performed by the calculation step of multiplying with the coefficient of an N-valuing result of pixel data of the specific pixel.

5. The method according to claim 4, wherein in order to perform the processing by the calculation step simultaneously with the N-valuing, the calculation step assumes in advance an N-valuing result of pixel data of the specific pixel.

6. The method according to claim 5, wherein the calculation step assumes any N-valuing results for the pixel data of the specific pixel but does not assume a result in which the N-valuing result is 0.

7. A computer program that can be stored in a computer-readable recording medium for causing a computer to perform a method, comprising:
an N-valuing step for N-valuing pixel data in the respective pixels included in an image to have a value of N (N is an integer of 2 or more) by using threshold values to the respective pixels to thereby obtain N-valuing results for the respective pixels; and
a calculation step for calculating threshold values to the respective pixels,
wherein the calculation step performs, prior to the respective pixels, a processing for multiplying with a coefficient the respective N-valuing results of a plurality of pixels by the N-valuing performed by the N-valuing step to calculate the sum to thereby calculate the threshold value and the N-valuing performed by the N-valuing step of pixel data of a specific pixel of the plurality of pixels is not after the processing performed by the calculation step of multiplying with the coefficient of an N-valuing result of pixel data of the specific pixel.

8. An apparatus, comprising:
an N-valuing unit for N-valuing pixel data in a pixel-of-interest to have a value of N (N is an integer of 2 or more) by using a threshold value to the pixel-of-interest to thereby obtain an N-valuing result for the pixel-of-interest; and
a calculation unit for using all N-valuing results conceivable as N-valuing results of the pixel-of-interest (0 and 1 when N is 2 and 0, 1, and 2 when N is 3) to calculate a threshold value of a pixel following the pixel-of-interest that corresponds to every one of the all N-valuing results before the N-valuing unit obtains the N-valuing result of the pixel-of-interest,
wherein after the N-valuing unit obtains the N-valuing result of the pixel-of-interest, a threshold value corresponding to the obtained the N-valuing result of the pixel-of-interest is selected from among threshold values calculated by the calculation unit and the selected threshold value is used to perform an N-valuing of the next pixel.
